(19) United States
(12) Patent Application Publication
(10) Pub. No.: US 2024/0372186 A1
(43) Pub. Date: Nov. 7, 2024

(54) LITHIUM-SULFUR CYLINDRICAL CELL CONFIGURED FOR DIRECT CONTACT

(71) Applicant: Lyten, Inc., San Jose, CA (US)

(72) Inventors: Jeffrey Bell, Santa Monica, CA (US); Engin Tuncer, Milpitas, CA (US); Zach Favors, Reno, NV (US); Brandan Taing, Sunnyvale, CA (US); Jesse Baucom, Santa Clara, CA (US)

(73) Assignee: Lyten, Inc., San Jose, CA (US)

(21) Appl. No.: 18/771,946

(22) Filed: Jul. 12, 2024

Related U.S. Application Data
(63) Continuation-in-part of application No. 18/203,563, filed on May 30, 2023.
(63) Continuation-in-part of application No. 18/104,559, filed on Feb. 1, 2023.
Application No. 18/104,559 is a continuation of application No. 17/726,774, filed on Apr. 22, 2022, now Pat. No. 11,600,876.
Application No. 17/726,774 is a continuation-in-part of application No. 17/709,156, filed on Mar. 30, 2022.
Application No. 17/709,156 is a continuation-in-part of application No. 17/694,407, filed on Mar. 14, 2022.
Application No. 17/694,407 is a continuation-in-part of application No. 17/672,960, filed on Feb. 16, 2022.
Application No. 17/672,960 is a continuation-in-part of application No. 17/666,753, filed on Feb. 8, 2022.
Application No. 17/666,753 is a continuation-in-part of application No. 17/584,666, filed on Jan. 26, 2022, now Pat. No. 11,367,895.
Application No. 17/584,666 is a continuation-in-part of application No. 17/578,240, filed on Jan. 18, 2022.
Application No. 17/578,240 is a continuation-in-part of application No. 17/563,183, filed on Dec. 28, 2021, now Pat. No. 11,404,692.
Application No. 17/563,183 is a continuation-in-part of application No. 17/383,803, filed on Jul. 23, 2021, now Pat. No. 11,309,545.
(60) Provisional application No. 63/396,531, filed on Aug. 9, 2022.
(60) Provisional application No. 63/235,892, filed on Aug. 23, 2021.

(51) Int. Cl. H01M 50/162; H01M 4/02; H01M 4/38; H01M 4/58; H01M 4/62; H01M 4/66; H01M 10/0525; H01M 10/0587; H01M 50/159; H01M 50/169; H01M 50/434; H01M 50/572

(52) U.S. Cl. CPC H01M 50/162; H01M 4/382; H01M 4/58; H01M 4/625; H01M 4/661; H01M 4/663; H01M 10/0525; H01M 10/0587; H01M 50/159; H01M 50/169; H01M 50/434; H01M 50/572; H01M 2004/021; H01M 2004/027; H01M 2004/028

(57) ABSTRACT

A battery includes a cylindrical shell defining an inner volume and a jelly roll disposed within the inner volume. The jelly roll includes an anode comprising lithium configured as a freestanding assembly having first and second sides, a double-sided cathode having a cathode current collector sandwiched between sulfur-containing first and second cathode layers, a first separator between the anode first side and cathode first layer, and a second separator in direct contact with the anode second side and cathode second layer. The double-sided cathode comprises particles each including a first zone of first pores and a second zone of second pores. The battery provides a lithium-sulfur cylindrical cell configuration with a freestanding lithium anode and double-sided sulfur cathode structure.

### CROSS-REFERENCE TO RELATED APPLICATIONS

The present application is a continuation-in-part of and claims priority to and the benefit of U.S. patent application Ser. No. 18/203,563 (published as US20240055728), filed May 30, 2023, entitled “LITHIUM CYLINDRICAL CELL CONFIGURED FOR DIRECT ELECTRODE-SEPARATOR CONTACT,” which in turn claims priority to and the benefit of U.S. Provisional Patent Application No. 63/396,531, filed Aug. 9, 2022, entitled “ENERGY STORAGE DEVICES EXHIBITING IMPROVED THERMAL AND ELECTRICAL CHARACTERISTICS AND REDUCED MASS, AND METHODS OF MAKING THE SAME,” which are assigned to the assignee hereof; the disclosures of all prior applications are considered part of and are incorporated by reference in this patent application.

The present application is a continuation-in-part of and claims priority to and the benefit of U.S. patent application Ser. No. 18/104,559 (published as US20230187744), filed Feb. 1, 2023, entitled “CYLINDRICAL LITHIUM-SULFUR BATTERY,” which in turn is a continuation application and claims priority to U.S. patent application Ser. No. 17/726,774 entitled “WOUND CYLINDRICAL LITHIUM-SULFUR BATTERY INCLUDING ELECTRICALLY-CONDUCTIVE CARBONACEOUS MATERIALS,” filed on Apr. 22, 2022, which is a continuation-in-part application and claims priority to U.S. patent application Ser. No. 17/709,156 entitled “LITHIUM-SULFUR BATTERY WITH A PROTECTIVE LAYER INCLUDING CARBON MATERIALS DECORATED WITH METAL-CONTAINING SUBSTANCES” filed on Mar. 30, 2022, which is a continuation-in-part application and claims priority to U.S. patent application Ser. No. 17/694,407 entitled “METHOD OF MANUFACTURING TAB-LESS CYLINDRICAL CELLS” filed on Mar. 14, 2022, which is a continuation-in-part application and claims priority to U.S. patent application Ser. No. 17/672,960 entitled “PLASTICIZER-INCLUSIVE POLYMERIC-INORGANIC HYBRID LAYER FOR A LITHIUM ANODE IN A LITHIUM-SULFUR BATTERY” filed on Feb. 16, 2022, which is a continuation-in-part application and claims priority to U.S. patent application Ser. No. 17/666,753 entitled “POLYMERIC-INORGANIC HYBRID LAYER FOR A LITHIUM ANODE” filed on Feb. 8, 2022, which is a continuation-in-part application and claims priority to U.S. patent application Ser. No. 17/584,666 entitled “SOLID-STATE ELECTROLYTE FOR LITHIUM-SULFUR BATTERIES” filed on Jan. 26, 2022, now U.S. Pat. No. 11,367,895, which is a continuation-in-part application and claims priority to U.S. patent application Ser. No. 17/578,240 entitled “LITHIUM-SULFUR BATTERY ELECTROLYTE COMPOSITIONS” filed on Jan. 18, 2022, which is a continuation-in-part application and claims priority to U.S. patent application Ser. No. 17/563,183 entitled “LITHIUM-SULFUR BATTERY CATHODE FORMED FROM MULTIPLE CARBONACEOUS REGIONS” filed on Dec. 28, 2021, now U.S. Pat. No. 11,404,692, which is a continuation-in-part of and claims priority to U.S. patent application Ser. No. 17/383,803 entitled “CARBONACEOUS MATERIALS FOR LITHIUM-SULFUR BATTERIES” filed on Jul. 23, 2021, now U.S. Pat. No. 11,309,545, which are assigned to the assignee hereof; the disclosures of all prior applications are considered part of and are incorporated by reference in this patent application for all purposes.

U.S. patent application Ser. No. 17/709,156 also claims priority to Provisional Patent Application No. 63/235,892 entitled “LITHIUM SULFUR BATTERY” filed on Aug. 23, 2021. The disclosures of all prior applications are assigned to the assignee hereof, and are considered part of and are incorporated by reference in this patent application in their respective entireties.

### FIELD OF THE INVENTION

The present invention relates to lithium-based batteries, and more specifically, to lithium-sulfur batteries in cylindrical or jelly roll form factors.

### BACKGROUND

Currently, cylindrical cell batteries benefit from use of lithium. For example, lithium-sulfur (or other lithium alloy composites) may provide rechargeable capabilities. Additionally, use of lithium-sulfur may allow for higher theoretical energy density, lower manufacturing costs, and lower environmental impact compared to lithium-ion (Li-ion) batteries. However, such cylindrical lithium-based batteries may encounter a number of issues. For example, the volume and weight of the case contributes (in excess of 10-13%) significantly to the mass of the overall cylindrical cell. As such, the battery capacity of lithium-based cylindrical cells is currently a fraction of its theoretical capacity (particularly if the volume of the case can be decreased).

As such, there is thus a need for addressing these and/or other issues associated with the prior art.

### SUMMARY

A freestanding lithium cylindrical cell may be provided. In use, the battery includes a cylindrical shell defining an inner volume, and a jelly roll disposed within the inner volume of the cylindrical shell. The jelly roll may comprise an anode comprising lithium, where the anode may be configured as a freestanding assembly. Additionally, the jelly roll may comprise a cathode comprising sulfur. Further, the jelly roll may comprise a first separator between a first side of the anode and a first side of the cathode, and a second separator in direct contact with the second side of the anode and with second side of the cathode.

In one embodiment, the anode may consist essentially of pure lithium. Additionally, the anode may comprise a lithium alloy including one or more of sulfur, magnesium, aluminum, alumina, lithium titanate, lithium lanthanum zirconium oxide (LLZO), calcium, tellerium, silicon, tin, zinc, or nickel. Further, the anode may comprise a lithium-magnesium anode, and/or a pure lithium anode. Further, the anode may comprise one of a lithium metal alloy anode, or a lithium composite anode.

In another embodiment, the jelly roll may include a current collector. The current collector may comprise at least one of copper, or nickel. Additionally, the jelly roll may comprise an assembly, wherein the assembly excludes copper.

In another embodiment, the battery may further comprise copper inlays within the jelly roll for tab welding. Additionally, at least one of the first separator or the second separator may be a carrier film for the anode. Further, the battery may further comprise an electrolyte disposed in the battery. The electrolyte may be configured to inhibit transport of lithium-containing polysulfide intermediate species from the cathode to the anode.

In another embodiment, the anode may be a solid lithium layer, and a current collector may be coupled to the anode. Additionally, the jelly roll may be wound using one or more mandrels.

In another embodiment, a top surface of the jelly roll may be not in contact with a top lid of the cylindrical shell. Additionally, a bottom surface of the jelly roll may be at least partially in contact with a negative contact surface of the cylindrical shell. Further, a casing of the battery may be formed from one or more of aluminum or steel. In one embodiment, a positive terminal of the battery may be welded to a current collector electrically coupled to the cathode, and a negative contact surface may be welded to a current collector coupled to the anode.

In another embodiment, the anode may comprise an alloy selected to surpass a minimum shear strength, where the minimum shear strength surpasses 50 N/cm2 Additionally, the anode may be an alloy selected to surpass a minimum mechanical strength, where the minimum mechanical strength surpasses 160 N/cm2.

In another embodiment, at least one of the first separator or the second separator may be configured for ion flow. Additionally, the battery may further comprise an inlay comprising copper, where the inlay may be one of a vertical strip or a horizontal strip. The vertical strip may be stamped into the anode, and the horizontal strip may be inlayed within the anode.

In another embodiment, the anode may function as a current collector. Additionally, the anode may consist of pure lithium, and at least one of the first separator or the second separator include a carrier film, where the carrier film increases the tensile strength of the pure lithium. Further, the anode may be a lithium alloy, and at least one of the first separator or the second separator may not include a carrier film.

In another embodiment, the cylindrical shell may have a diameter in a range from approximately 18.4 millimeter (mm) to approximately 18.6 mm and a length in a range from approximately 65.1 mm to approximately 65.3 mm. Additionally, the cylindrical shell may be congruent with an 18560 cell. Further, at least one of the anode or the cathode may not include a tab.

In another embodiment, the freestanding assembly may be a substrate-less electrode. Additionally, the freestanding assembly is a copper-free assembly. Further, the anode may lack a separate layer for a current collector. For example, the may lithium function as a current collector.

### BRIEF DESCRIPTION OF THE DRAWINGS

FIG. 1A illustrates prior art.

FIG. 1B-1 illustrates a cross-cut perspective of a cell with a free standing lithium anode, in accordance with one embodiment.

FIG. 1B-2 illustrates a cross-cut perspective of a cell with a free standing lithium anode, in accordance with one embodiment.

FIG. 1C-1 illustrates a cross-cut perspective of FIG. 1B-1 in the context of a cylindrical cell, in accordance with one embodiment.

FIG. 1C-2 illustrates a cross-cut perspective of FIG. 1B-1 in the context of a cylindrical cell, in accordance with one embodiment.

FIG. 1C-3 illustrates a cross-cut perspective of FIG. 1B-1 in the context of a cylindrical cell, in accordance with one embodiment.

FIG. 1C-4 illustrates a cross-cut perspective of FIG. 1B-1 in the context of a cylindrical cell, in accordance with one embodiment.

FIG. 1C-5 illustrates a cross-cut perspective of FIG. 1B-2 in the context of a cylindrical cell, in accordance with one embodiment.

FIG. 1C-6 illustrates a cross-cut perspective of FIG. 1B-2 in the context of a cylindrical cell, in accordance with one embodiment.

FIG. 1C-7 illustrates a cross-cut perspective of FIG. 1B-2 in the context of a cylindrical cell, in accordance with one embodiment.

FIG. 1C-8 illustrates a cross-cut perspective of FIG. 1B-2 in the context of a cylindrical cell, in accordance with one embodiment.

FIG. 1D illustrates a cross-cut perspective of a cylindrical cell with a free standing lithium anode, in accordance with one embodiment.

FIG. 2 illustrates a side perspective of a cylindrical cell with a free standing lithium anode, in accordance with one embodiment.

FIG. 3 illustrates a close-up perspective of a cylindrical cell with a free standing lithium anode, in accordance with one embodiment.

FIG. 4 illustrates a top-down perspective of a cylindrical cell with a free standing lithium anode, in accordance with one embodiment.

FIG. 5 illustrates a case for a cylindrical cell with a free standing lithium anode, in accordance with one embodiment.

FIG. 6 illustrates an assembled cylindrical cell with a free standing lithium anode, in accordance with one embodiment.

FIG. 7 illustrates an assembled cylindrical cell with a free standing lithium anode, in accordance with one embodiment.

FIG. 8 illustrates a jelly roll configuration for a cylindrical cell with a free standing lithium anode, in accordance with one embodiment.

FIG. 9 illustrates a current collector for a cylindrical cell with a free standing lithium anode, in accordance with one embodiment.

FIG. 10 illustrates a gasket for a cylindrical cell with a free standing lithium anode, in accordance with one embodiment.

FIG. 11 illustrates a positive terminal for a cylindrical cell with a free standing lithium anode, in accordance with one embodiment.

FIG. 12 illustrates a top insulator for a cylindrical cell with a free standing lithium anode, in accordance with one embodiment.

FIG. 13 illustrates a reduced copper-configured cylindrical cell, in accordance with one embodiment.

FIG. 14 illustrates a reduced copper-configured cylindrical cell, in accordance with one embodiment.

FIG. 15 illustrates a free standing lithium anode, in accordance with one embodiment.

FIG. 16 illustrates production images for a cylindrical cell with a free standing lithium anode, in accordance with one embodiment.

FIG. 17 illustrates production images for a cylindrical cell with a free standing lithium anode, in accordance with one embodiment.

FIG. 18 illustrates computed tomography scans of a cylindrical cell with a free standing lithium anode, in accordance with one embodiment.

FIG. 19A through FIG. 19Y depict structured carbons, in accordance with some embodiments.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Commercial lithium (Li)-ion batteries have been made into cylindrical and jelly roll prismatic form factors. Given that Li—S batteries have higher theoretical specific capacity and specific energy, it is desirable to make cylindrical or jelly roll prismatic Li—S batteries. A conventional cylindrical or a jelly roll prismatic battery cell requires jelly rolling of a cathode, an anode, and separators in a radial bending fashion. The cathode and the anode must have a robust mechanical structure to withstand the bending forces in the winding process to avoid any internal short circuits or capacity decrease.

A Li—S battery that may be capable of powering electric vehicles, energy storage systems, or satellites due to its high theoretical energy density is associated with several undesirable characteristics. For example, the polysulfide shuttle effect may significantly decrease the cycling stability, cause irreversible loss of sulfur, and even cause severe lithium anode corrosion. A volume expansion of cathode active materials caused by the cathode reaction during the discharge cycle of the Li—S battery can damage the mechanical structure of the cathode and cause potential hazards. Further, the volume and weight of the case may contribute (in excess of 10-13%) significantly to the mass of the overall cylindrical cell.

Given the fragility of using lithium within battery structures (particularly within the context of jelly roll configuration), lithium is often paired with a substrate (such as copper) to reinforce its tensile and mechanical strength. For example, a pure lithium anode in a cylindrical cell is likely to break apart due to the wind tension.

The present disclosure resolves these and other issues with lithium cylindrical batteries. In particular, a freestanding lithium cylindrical cell is provided. In use, the battery includes a cylindrical shell defining an inner volume, and a jelly roll disposed within the inner volume of the cylindrical shell. The jelly roll may comprise an anode comprising lithium, where the anode may be configured as a freestanding assembly. Additionally, the jelly roll may comprise a cathode comprising sulfur. Further, the jelly roll may comprise a first separator between a first side of the anode and a first side of the cathode, and a second separator in direct contact with the second side of the anode and with second side of the cathode.

In various implementations, the Li—S battery contains a jelly roll within a battery shell. In some aspects, the Li—S battery may contain one or more tabs to connect the cathode and the anode of the Li—S battery to the positive and negative terminal, respectively, of the shell.

Particular implementations of the subject matter described in this disclosure can be implemented to realize one or more of the following potential advantages. Existing cylindrical or jelly roll prismatic batteries are limited to Li-ion battery chemistries. Such chemistries have imposed limitations on battery capacities and energy densities regardless of research and development or breakthroughs on composition materials. As a result, existing Li-ion batteries may not be used for certain applications that would require high energy densities such as an energy storage system for powering a satellite or an electric vehicle capable of a longer range. In some implementations, the techniques disclosed herein can be used to manufacture a cylindrical or jelly roll prismatic Li—S battery with a much higher battery capacity and energy densities compared to commercial Li-ion batteries.

Additionally, the techniques disclosed herein can be used to manufacture an electrode that has reduced overall volume (due to it being freestanding) and increased energy density (wh/kg and wh/L).

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

Within the context of the present description, a freestanding electrode refers to an electrode that lacks a substrate. For example, in various embodiments, a freestanding electrode may include an electrode constructed of pure lithium, a lithium alloy, a lithium composite, a pure lithium with carrier film, etc. In this manner, a freestanding electrode may not require a typical copper substrate (or any other typical substrate) to function. In one embodiment, a freestanding electrode may require a carrier film.

### Descriptions of Exemplary Embodiments

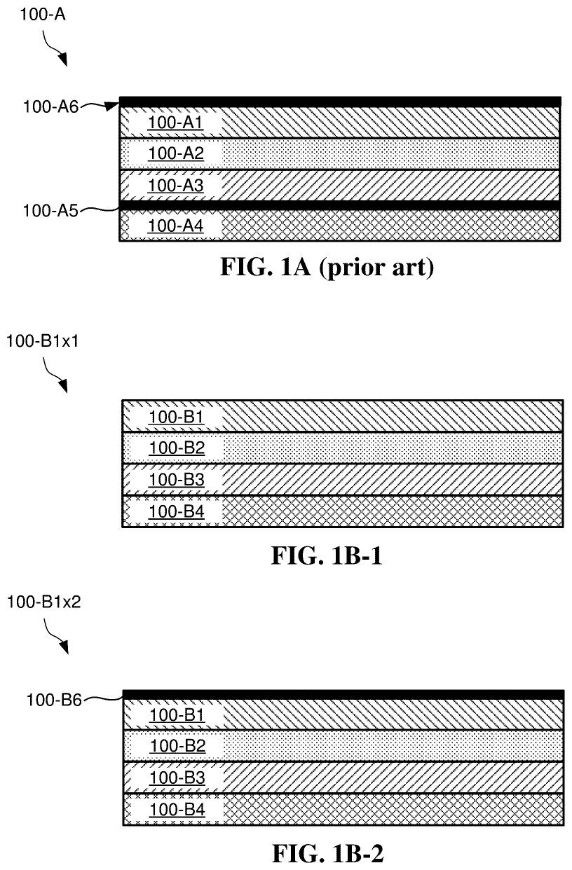

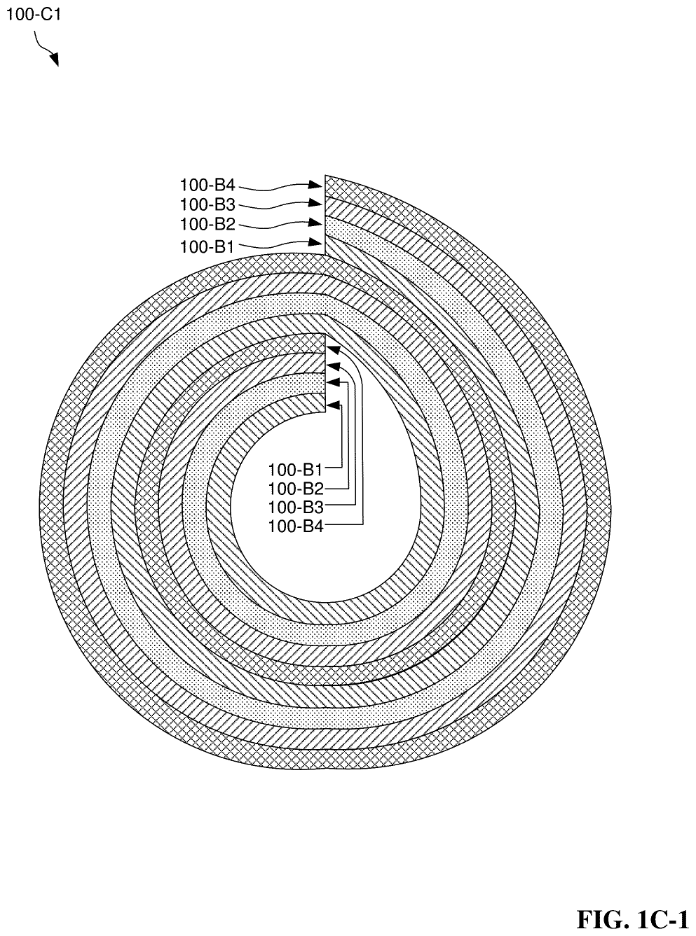

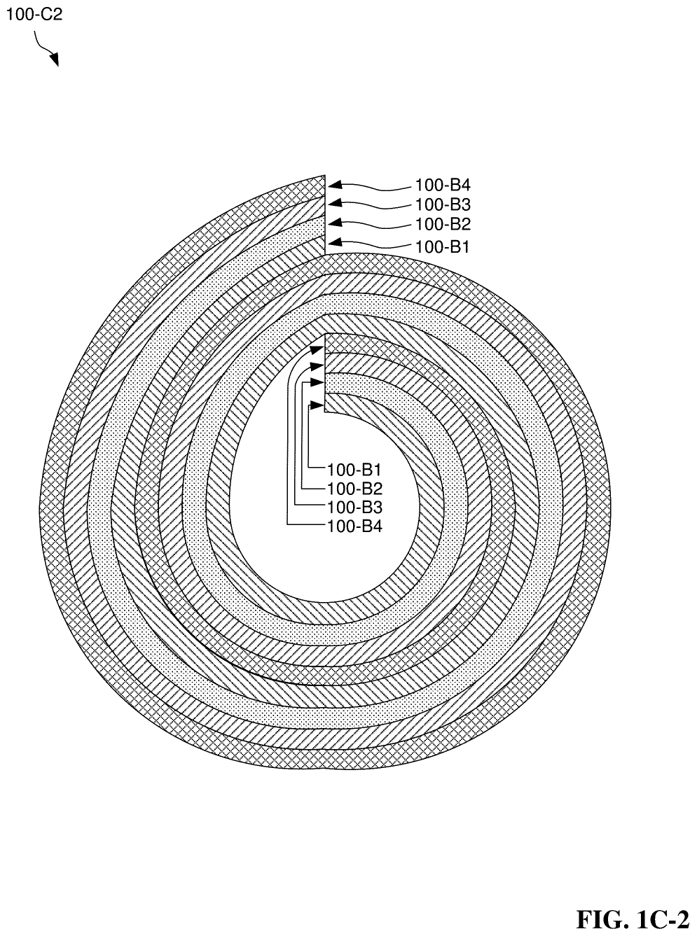

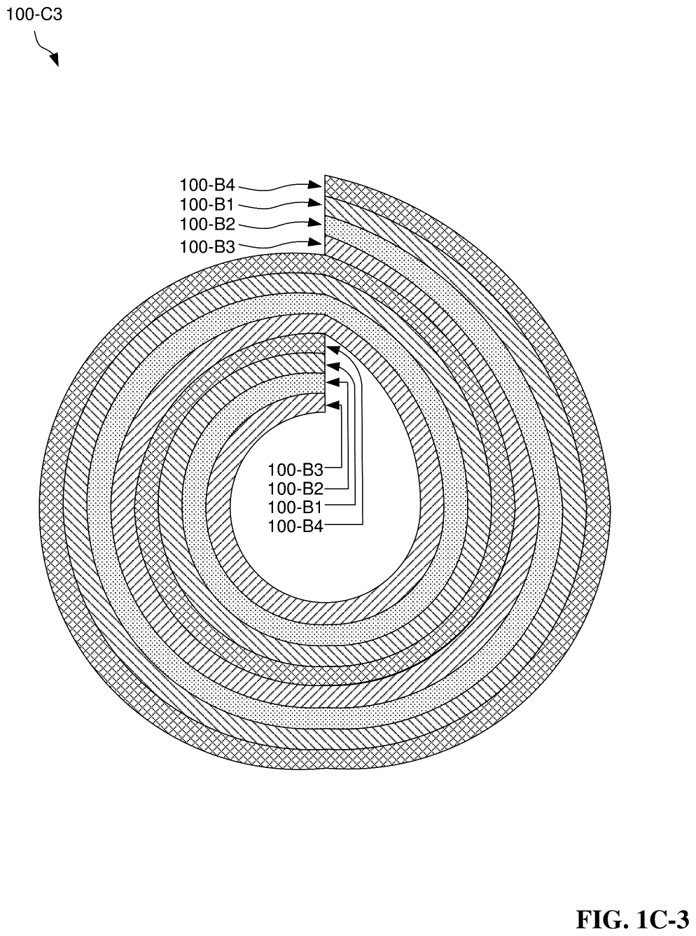

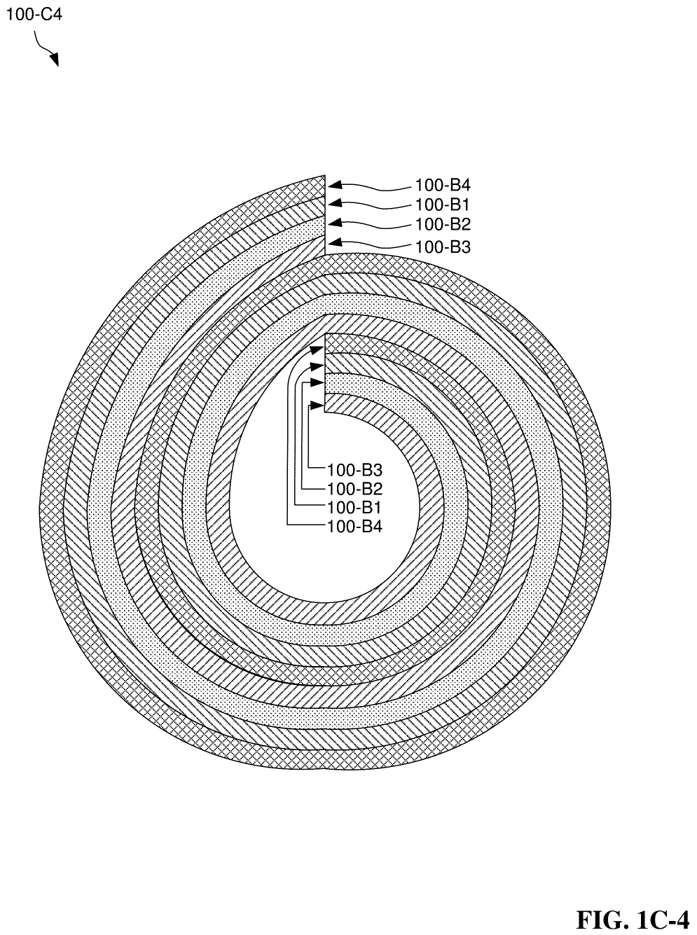

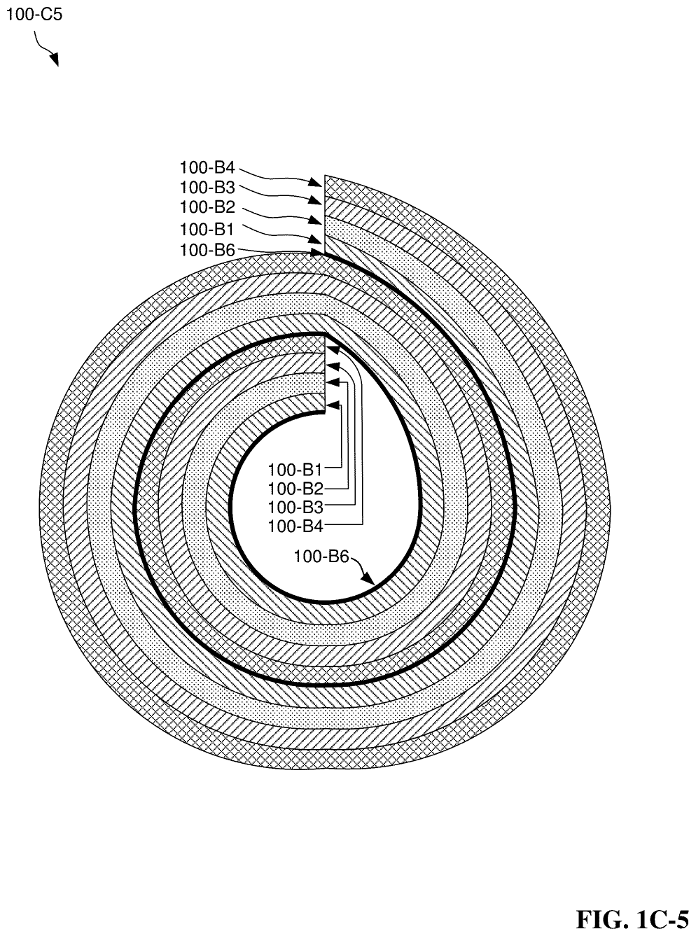

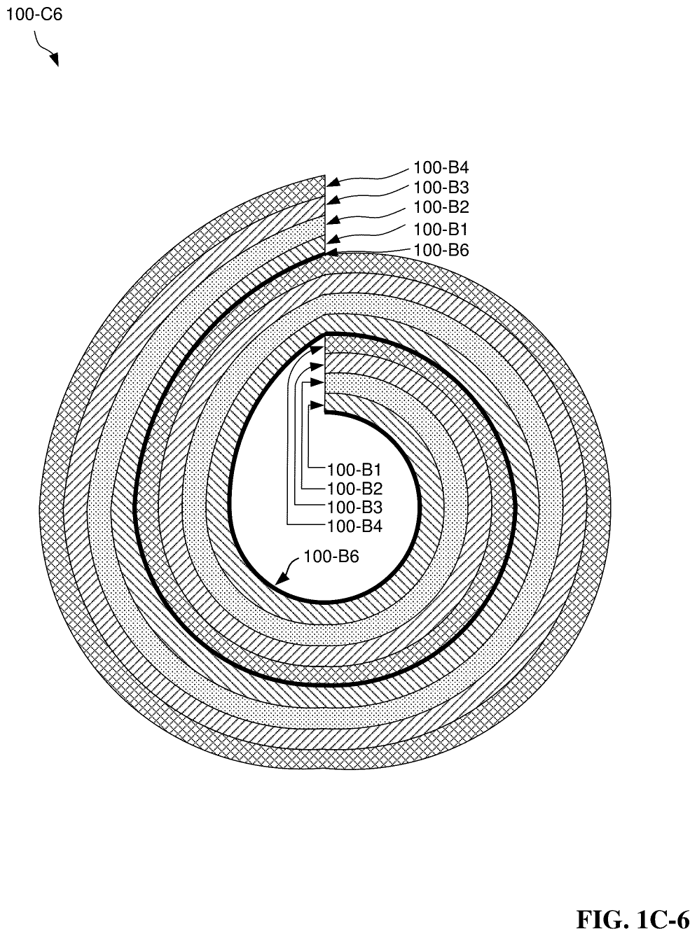

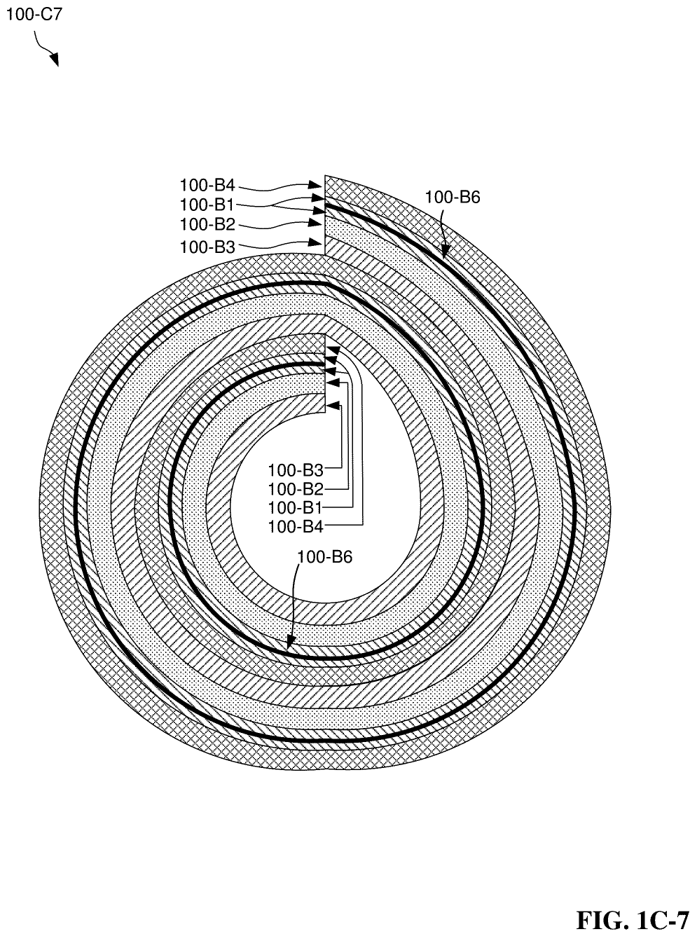

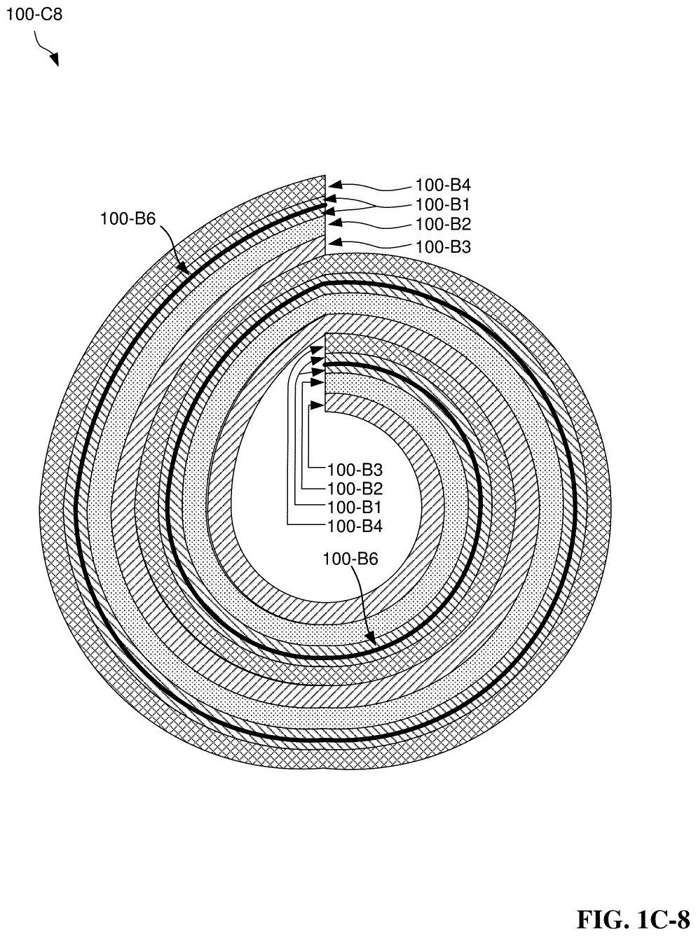

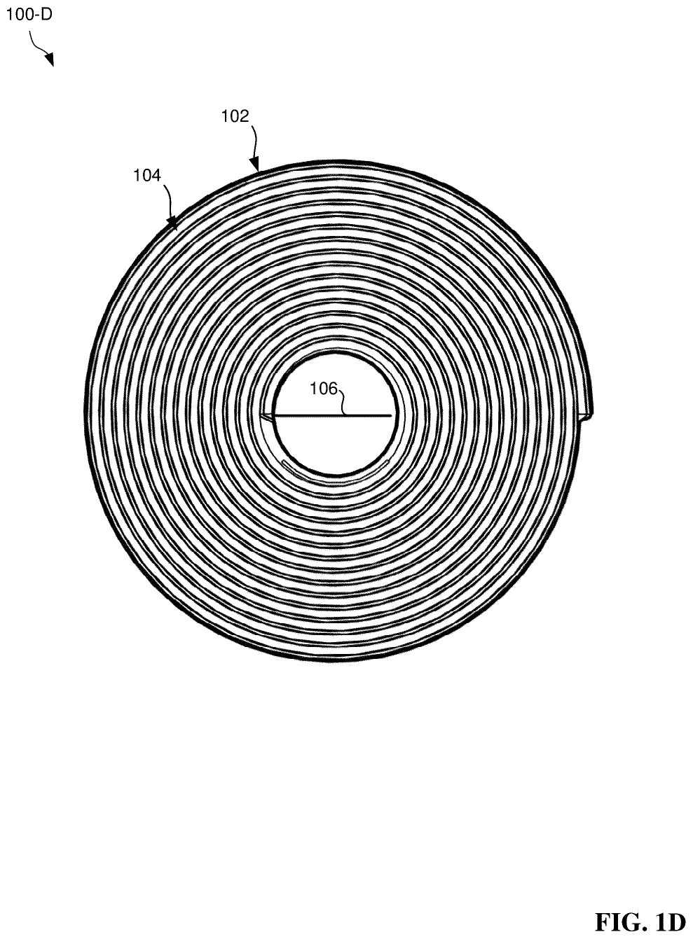

FIG. 1A illustrates prior art 100-A. As shown, the prior art 100-A displays a cross-cut layered display of a cylindrical cell (prior to being wound). The prior art 100-A shows a cell containing a cathode 100-A1, a first separator 100-A2, an anode 100-A3, a second separator 100-A4, an anode substrate 100-A5, and a cathode current collector 100-A6. In conventional systems, if lithium were primarily used, for example, in the anode 100-A3, the anode substrate 100-A5 may include a layer of copper. The copper may be used both as a current collector and to reinforce the anode 100-A3. In this manner, a first side of the anode 100-A3 comes in contact with a first side of the first separator 100-A2, and a second side of the anode 100-A3 comes in contact with a first side of the anode substrate 100-A5.

FIG. 1B-1 illustrates a cross-cut perspective 100-B1x1 of a cell with a free standing lithium anode, in accordance with one embodiment. The cross-cut perspective 100-B1x1 shows a cross-cut layered display of a cylindrical cell (prior to being wound). The cross-cut perspective 100-B1x1 shows a cell containing a cathode 100-B1, a first separator 100-B2, an anode 100-B3, and a second separator 100-B4. In comparing the cross-cut perspective 100-B to the prior art 100-A, it is to be appreciated that the cross-cut perspective 100-B does not include a substrate for the anode 100-B3. In this manner, the anode 100-B3 is a free-standing layer (without a substrate) which differs from conventional systems.

This approach of having a free-standing layer for the anode was hitherto impossible to achieve. For example, using conventional techniques, if an anode constructed primarily of lithium were wound for a cylindrical cell and which did not have a substrate (to increase its tensile strength), the anode would crack (and otherwise be rendered unfit for use). Thus, the techniques disclosed herein allow for a free-standing anode (constructed primarily of lithium and/or lithium alloys, as detailed further herein) which does not require use of a substrate in order to function.

With this context, it is to be appreciated that a first side of the anode 100-B3 comes in contact with a first side of the first separator 100-B2, and a second side of the anode 100-B3 comes in contact with a first of the second separator 100-B4. In comparing FIG. 1B-1, again, to FIG. 1A, it is to be appreciated that with prior art systems, the anode typically would sandwiched between a separator and an anode substrate, whereas with FIG. 1B-1, the anode 100-B3 is sandwiched directly between the first separator 100-B2 and the second separator 100-B4.

It is to be appreciated that the anode substrate (such as the anode substrate 100-B5) may include any substrate and/or current collector that is layered next to the anode (such as the anode 100-A3).

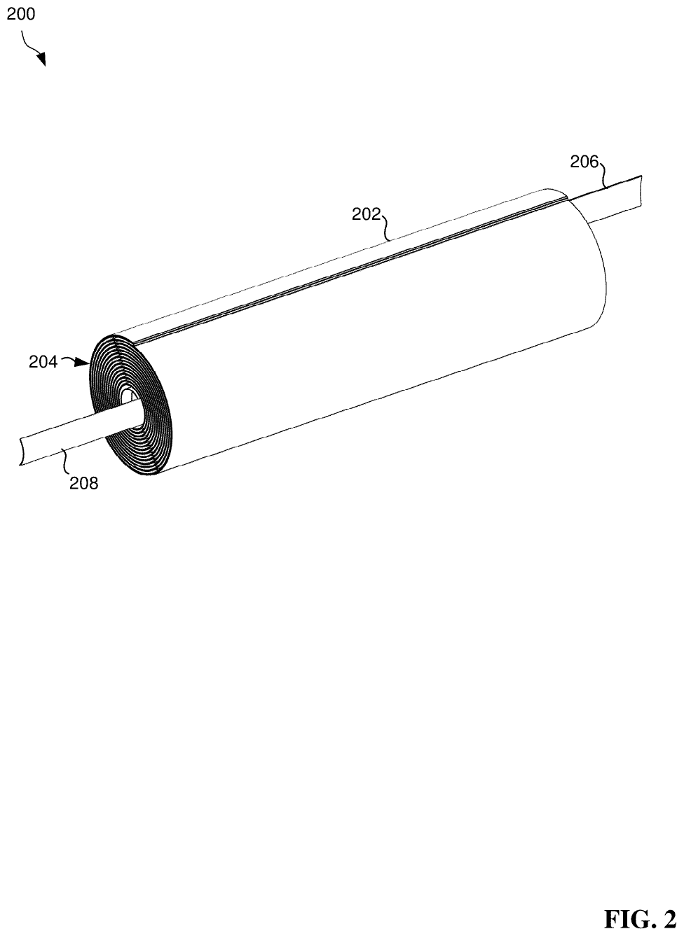

FIG. 1B-2 illustrates a cross-cut perspective 100-B1x2 of a cell with a free standing lithium anode, in accordance with one embodiment. The cross-cut perspective 100-B1x2 shows a cross-cut layered display of a cylindrical cell (prior to being wound). The cross-cut perspective 100-B1x2 shows a cell containing a cathode 100-B1, a first separator 100-B2, an anode 100-B3, a second separator 100-B4, and a cathode current collector 100-B6. In comparing the cross-cut perspective 100-B2 to the prior art 100-A, it is to be appreciated that the cross-cut perspective 100-B does not include a substrate for the anode 100-B3, but does include a substrate for the cathode 100-B1. In this manner, the anode 100-B3 is a free-standing layer (without a substrate) which differs from conventional systems, and the cathode 100-B1 may still include a substrate (such as a current collector). It is noted that the free-standing capabilities of the anode 100-B3 apply equally to the FIG. 1B-2 as previously discussed within the context of FIG. 1B-1.

FIG. 1C-1 illustrates a cross-cut perspective 100-C1 of FIG. 1B-1 in the context of a cylindrical cell, in accordance with one embodiment. As an option, the cross-cut perspective 100-C1 may be implemented in the context of any one or more of the embodiments set forth in any previous and/or subsequent figure(s) and/or description thereof. Of course, however, the cross-cut perspective 100-C1 may be implemented in the context of any desired environment. Further, the aforementioned definitions may equally apply to the description below.

As shown, the cross-cut perspective 100-C1 shows a cylindrical cell in a first counter-clockwise configuration containing a cathode 100-B1, a first separator 100-B2, an anode 100-B3, and a second separator 100-B4. Within the context of a cylindrical cell (as shown within FIG. 1C-1), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-1, a first side of the anode 100-B3 comes in direct contact with the first separator 100-B2 and the second side of the anode 100-B3 comes in direct contact with the second separator 100-B4. Additionally, a first side of the cathode 100-B1 comes in direct contact with the second separator 100-B4 and a second side of the cathode 100-B1 comes in direct contact with the second separator 100-B4.

FIG. 1C-2 illustrates a cross-cut perspective 100-C2 of FIG. 1B-1 in the context of a cylindrical cell, in accordance with one embodiment. As an option, the cross-cut perspective 100-C2 may be implemented in the context of any one or more of the embodiments set forth in any previous and/or subsequent figure(s) and/or description thereof. Of course, however, the cross-cut perspective 100-C2 may be implemented in the context of any desired environment. Further, the aforementioned definitions may equally apply to the description below.

As shown, the cross-cut perspective 100-C2 shows a cylindrical cell in a first clockwise configuration containing a cathode 100-B1, a first separator 100-B2, an anode 100-B3, and a second separator 100-B4. Within the context of a cylindrical cell (as shown within FIG. 1C-2), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-2, both sides of the anode 100-B3 and the cathode 100-B1 come in direct contact with the first separator 100-B2 and the second separator 100-B4.

FIG. 1C-3 illustrates a cross-cut perspective 100-C3 of FIG. 1B-1 in the context of a cylindrical cell, in accordance with one embodiment. As an option, the cross-cut perspective 100-C3 may be implemented in the context of any one or more of the embodiments set forth in any previous and/or subsequent figure(s) and/or description thereof. Of course, however, the cross-cut perspective 100-C3 may be implemented in the context of any desired environment. Further, the aforementioned definitions may equally apply to the description below.

As shown, the cross-cut perspective 100-C3 shows a cylindrical cell in a second counter-clockwise configuration containing a cathode 100-B1, a first separator 100-B2, an anode 100-B3, and a second separator 100-B4. Within the context of a cylindrical cell (as shown within FIG. 1C-3), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-3, a first side of the anode 100-B3 comes in direct contact with the first separator 100-B2 and the second side of the anode 100-B3 comes in direct contact with the second separator 100-B4. Additionally, a first side of the cathode 100-B1 comes in direct contact with the second separator 100-B4 and a second side of the cathode 100-B1 comes in direct contact with the second separator 100-B4. In contrasting FIG. 1C-3 to FIG. 1C-1, it is noted that the configuration of the layers (namely the layering of the cathode and anode) may differ, based on whether the cathode or the anode are on the inside or outside of the winding.

FIG. 1C-4 illustrates a cross-cut perspective 100-C4 of FIG. 1B-1 in the context of a cylindrical cell, in accordance with one embodiment. As an option, the cross-cut perspective 100-C4 may be implemented in the context of any one or more of the embodiments set forth in any previous and/or subsequent figure(s) and/or description thereof. Of course, however, the cross-cut perspective 100-C4 may be implemented in the context of any desired environment. Further, the aforementioned definitions may equally apply to the description below.

As shown, the cross-cut perspective 100-C4 shows a cylindrical cell in a second clockwise configuration containing a cathode 100-B1, a first separator 100-B2, an anode 100-B3, and a second separator 100-B4. Within the context of a cylindrical cell (as shown within FIG. 1C-4), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. In like manner, a first side of the cathode 100-B1 comes in contact with a second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4.

As such, in the jelly roll configuration of FIG. 1C-4, a first side of the anode 100-B3 comes in direct contact with the first separator 100-B2 and the second side of the anode 100-B3 comes in direct contact with the second separator 100-B4. Additionally, a first side of the cathode 100-B1 comes in direct contact with the second separator 100-B4 and a second side of the cathode 100-B1 comes in direct contact with the second separator 100-B4. In contrasting FIG. 1C-4 to FIG. 1C-2, it is noted that the configuration of the layers (namely the layering of the cathode and anode) may differ, based on whether the cathode or the anode are on the inside or outside of the winding.

FIG. 1C-5 illustrates a cross-cut perspective 100-C5 of FIG. 1B-2 in the context of a cylindrical cell, in accordance with one embodiment. As an option, the cross-cut perspective 100-C5 may be implemented in the context of any one or more of the embodiments set forth in any previous and/or subsequent figure(s) and/or description thereof. Of course, however, the cross-cut perspective 100-C5 may be implemented in the context of any desired environment. Further, the aforementioned definitions may equally apply to the description below.

As shown, the cross-cut perspective 100-C5 shows a cylindrical cell in a first counter-clockwise configuration containing a cathode 100-B1, a first separator 100-B2, an anode 100-B3, a second separator 100-B4, and a cathode current collector 100-B6. Within the context of a cylindrical cell (as shown within FIG. 1C-5), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with a second side of the first separator 100-B2, and a second side of the cathode 100-B1 comes in contact with the cathode current collector 100-B6, which in turn, comes in contact with the second side of the second separator 100-B4. In this manner, the cathode 100-B1 may be in direct contact with both the first separator 100-B2 and the cathode current collector 100-B6.

As such, in the jelly roll configuration of FIG. 1C-5, a first side of the anode 100-B3 comes in direct contact with the first separator 100-B2 and the second side of the anode 100-B3 comes in direct contact with the second separator 100-B4.

FIG. 1C-6 illustrates a cross-cut perspective 100-C6 of FIG. 1B-2 in the context of a cylindrical cell, in accordance with one embodiment. As an option, the cross-cut perspective 100-C6 may be implemented in the context of any one or more of the embodiments set forth in any previous and/or subsequent figure(s) and/or description thereof. Of course, however, the cross-cut perspective 100-C6 may be implemented in the context of any desired environment. Further, the aforementioned definitions may equally apply to the description below.

As shown, the cross-cut perspective 100-C6 shows a cylindrical cell in a first clockwise configuration containing a cathode 100-B1, a first separator 100-B2, an anode 100-B3, a second separator 100-B4, and a cathode current collector 100-B6. Within the context of a cylindrical cell (as shown within FIG. 1C-6), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with a second side of the first separator 100-B2, and a second side of the cathode 100-B1 comes in contact with the cathode current collector 100-B6, which in turn, comes in contact with the second side of the second separator 100-B4. In this manner, the cathode 100-B1 may be in direct contact with both the first separator 100-B2 and the cathode current collector 100-B6.

As such, in the jelly roll configuration of FIG. 1C-6, a first side of the anode 100-B3 comes in direct contact with the first separator 100-B2 and the second side of the anode 100-B3 comes in direct contact with the second separator 100-B4.

FIG. 1C-7 illustrates a cross-cut perspective 100-C7 of FIG. 1B-2 in the context of a cylindrical cell, in accordance with one embodiment. As an option, the cross-cut perspective 100-C7 may be implemented in the context of any one or more of the embodiments set forth in any previous and/or subsequent figure(s) and/or description thereof. Of course, however, the cross-cut perspective 100-C7 may be implemented in the context of any desired environment. Further, the aforementioned definitions may equally apply to the description below.

As shown, the cross-cut perspective 100-C7 shows a cylindrical cell in a second counter-clockwise configuration containing a cathode 100-B1, a first separator 100-B2, an anode 100-B3, a second separator 100-B4, and a cathode current collector 100-B6. Within the context of a cylindrical cell (as shown within FIG. 1C-7), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with the second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4. Further, as shown, the cathode current collector 100-B6 may be embedded within the cathode 100-B1. For example, the cathode 100-B1 may be a double sided cathode with the cathode current collector 100-B6 sandwiched between a first layer of the cathode 100-B1 and a second layer of the cathode 100-B1. It is to be appreciate further that as discussed herein, the cathode 100-B1 may include a single sided cathode or a double side cathode, and the cathode current collector 100-B6 may be located to a single side of the cathode 100-B1, or may be sandwiched between a first layer and second layer of the cathode 100-B1.

As such, in the jelly roll configuration of FIG. 1C-7, a first side of the anode 100-B3 comes in direct contact with the first separator 100-B2 and the second side of the anode 100-B3 comes in direct contact with the second separator 100-B4. In contrasting FIG. 1C-7 to FIG. 1C-5, it is noted that the configuration of the layers (namely the layering of the cathode and anode) may differ, based on whether the cathode or the anode are on the inside or outside of the winding.

FIG. 1C-8 illustrates a cross-cut perspective 100-C8 of FIG. 1B-2 in the context of a cylindrical cell, in accordance with one embodiment. As an option, the cross-cut perspective 100-C8 may be implemented in the context of any one or more of the embodiments set forth in any previous and/or subsequent figure(s) and/or description thereof. Of course, however, the cross-cut perspective 100-C8 may be implemented in the context of any desired environment. Further, the aforementioned definitions may equally apply to the description below.

As shown, the cross-cut perspective 100-C8 shows a cylindrical cell in a second clockwise configuration containing a cathode 100-B1, a first separator 100-B2, an anode 100-B3, a second separator 100-B4, and a cathode current collector 100-B6. Within the context of a cylindrical cell (as shown within FIG. 1C-8), a first side of the anode 100-B3 comes in contact with a first side of the first separator 100-B2, and a second side of the anode 100-B3 comes in contact with a first side of the second separator 100-B4. In this manner, the anode 100-B3 may be in direct contact with both the first separator 100-B2 and the second separator 100-B4. A first side of the cathode 100-B1 comes in contact with the second side of the first separator 100-B2, and a second side of the cathode 100-B1 comes in contact with a second side of the second separator 100-B4. In this manner, the cathode 100-B1 may be in direct contact with both the first separator 100-B2 and the second separator 100-B4. Further, as shown, the cathode current collector 100-B6 may be embedded within the cathode 100-B1. For example, the cathode 100-B1 may be a double sided cathode with the cathode current collector 100-B6 sandwiched between a first layer of the cathode 100-B1 and a second layer of the cathode 100-B1.

As such, in the jelly roll configuration of FIG. 1C-8, a first side of the anode 100-B3 comes in direct contact with the first separator 100-B2 and the second side of the anode 100-B3 comes in direct contact with the second separator 100-B4. In contrasting FIG. 1C-8 to FIG. 1C-6, it is noted that the configuration of the layers (namely the layering of the cathode and anode) may differ, based on whether the cathode or the anode are on the inside or outside of the winding.

FIG. 1D illustrates a cross-cut perspective of a cylindrical cell 100-D with a free standing lithium anode, in accordance with one embodiment. It is to be appreciated that the cross-cut perspective of a cylindrical cell 100-D presents one possible configuration of a cylindrical cell (i.e. rolled up electrode body). As an option, the cylindrical cell 100-D may be implemented in the context of any one or more of the embodiments set forth in any previous and/or subsequent figure(s) and/or description thereof. Of course, however, the cylindrical cell 100-D may be implemented in the context of any desired environment. Further, the aforementioned definitions may equally apply to the description below.

It is to be appreciated that the FIG. 1D displays the cross-cut perspective 100-B in wound-form.

As shown, the cross-cut perspective of the cylindrical cell 100 may take the form of a jelly roll style construction comprised of a compressed lithium anode material 104 adhered to a separator 102. The construction may include a tab 106 attached to a current collector integrated within the cylindrical cell. Further, the construction may include a cathode material. For purposes of simplification, the cross-cut perspective of the cylindrical cell 100 displays compressed layers (which may include, in one embodiment, an anode layer and a cathode layer separated by a separator).

In one embodiment, the separator 102 may be adhered to a sheet of the lithium anode material 104. When the cylindrical cell is wound, the separator 102 may come in contact the lithium anode material 104.

Further, in one embodiment, prior to winding, the layering of the cell may include a layer for a cathode material, a layer for a first separator, a layer for an anode material, and a layer for a second separator. As the layers are wound (when the structure of all layers is rolled over itself repeatedly), the jelly roll structure of the lithium battery may be created where the cathode and anode layers comprise every other layer in a cross-section representation.

In another embodiment, the lithium anode material 104 may be comprised of any metal(s) suitable for battery-storage purposes, including lithium-containing alloys like lithium-magnesium (Li—Mg) and lithium-sulfur (Li—S). In a related embodiment, the lithium anode material 104 may be manufactured as a roll of material affixed to another carrier film compound capable of simultaneously maintaining the integrity of the lithium-containing alloy in question and serving as a separator compound between the anode material 104 and a cathode. It should be noted that incorporating the carrier film may help preserve the integrity of lithium-containing alloys where the requisite (industry-standard) tensile strength of such winding/wrapping may conform to 27-28 Newtons of stretching force.

Further, in one embodiment the lithium anode material 104 may theoretically include pure lithium. In such an embodiment, the lithium anode material 104 may require a carrier film. The carrier film may function as a separator (for lithium anode material 104), and may be used to increase the tensile strength of the pure lithium such that it retains mechanical integrity as it goes through the winding process. In another embodiment, lithium anode material 104 may be an alloy composition such that the composition inherently can withstand the winding demands. In such an embodiment, a carrier film may not be needed but a separator can still be used to ensure proper insulation and electron flow.

In still another embodiment, the separator 102 may be comprised of any non-conductive, non-corrosive material suitable for insulating the anode material 104 (as well as for a cathode material layer). Additionally, the separator may allow for electron flow (between the cathode material and the anode material, and vice versa) and/or function as an insulator. Additionally, more than one separator may be present within the cylindrical configuration. For example, in a four layer assembly (e.g. cathode, first separator, anode, second separator, etc.), a first separator may function as an insulator, and a second insulator may function to allow electron flow. It is to be appreciated that within the context of FIG. 1D (and other figures described herein), for simplicity purposes, the separators are designated in the singular (as a “separator”). However, even within such context (of one separator being called out), it is to be understood that a common cylindrical assembly would be comprised of a cathode, a first separator, an anode, and a second separator, consistent with the layered details associated with FIG. 1B.

In various embodiments, two or more separators may be uncoated or coated with either a polymer (such as but not limited to PVDF, PEO, PMMA, PAA, PVA, etc.), a salt (such as but not limited to LIFSI, LITFSI, LIPF6, etc.), a metal (such as but not limited to tungsten, aluminum, selenium, tellerium), and/or a ceramic (such as but not limited to alumina, aluminum fluoride, etc.). In one embodiment, one of the two or more separators may face towards the cathode or anode (with a second separator facing towards the other), and in some cases may face both the cathode and the anode (such as when sandwiched between the anode and cathode, when acting as an adhesive to keep the separator tightly bound to the anode, when functioning as a mechanism to block polysulfides, when functioning to even out current density, etc.).

Additionally, the two or more separators may be constructed of various materials, including but not limited to polymer, ceramic, metal and/or salt. Additionally, the two or more separators may be coated on one or more sides. Additionally, the coating may be for one of electrochemical, mechanical, and/or or safety considerations. Further, the coating may allow for adhesion to an electrode, thermal distribution, mechanical reinforcement of an electrode or the separator itself, even out a current distribution, and/or block polysulfides.

In this manner, the two or more separators may be constructed of the same (or potentially different) materials, and may have same (or potentially different) functions, configured as needed depending on the needs of the cylindrical cell.

In various embodiments, the cross-cut perspective of the cylindrical cell 100 may be configured without a current collector. In such an embodiment, the lithium electrode may function as the current collector (and be connected directly to the tab 106).

As such, a freestanding lithium cylindrical battery may be achieved such that traditional use of copper (within the context of a cylindrical battery) may not be necessary. It is further noted that the freestanding lithium cylindrical battery may still integrate copper, but in a manner the conventionally is not done in the industry. For example, as explained hereinbelow more fully, copper may be compressed between two lithium layers, stamped, and/or inlayed from a roll.

Further, in various embodiments, a freestanding lithium cylindrical cell may be provided. In use, the battery includes a cylindrical shell defining an inner volume, and a jelly roll disposed within the inner volume of the cylindrical shell. The jelly roll may comprise an anode comprising lithium, where the anode may be configured as a freestanding assembly. Additionally, the jelly roll may comprise a cathode comprising sulfur. Further, the jelly roll may comprise a first separator between a first side of the anode and a first side of the cathode, and a second separator in direct contact with the second side of the anode and with second side of the cathode.

In one embodiment, the anode may consist essentially of pure lithium. Additionally, the anode may comprise a lithium alloy including one or more of sulfur, magnesium, aluminum, alumina, lithium titanate, lithium lanthanum zirconium oxide (LLZO), calcium, tellerium, silicon, tin, zinc, or nickel. Further, the anode may comprise a lithium-magnesium anode, and/or a pure lithium anode. Further, the anode may comprise one of a lithium metal alloy anode, or a lithium composite anode.

In another embodiment, the jelly roll may include a current collector. The current collector may comprise at least one of copper, or nickel. Additionally, the jelly roll may comprise an assembly, wherein the assembly excludes copper.

In another embodiment, the battery may further comprise copper inlays within the jelly roll for tab welding. Additionally, at least one of the first separator or the second separator may be a carrier film for the anode. Further, the battery may further comprise an electrolyte disposed in the battery. The electrolyte may be configured to inhibit transport of lithium-containing polysulfide intermediate species from the cathode to the anode.

In another embodiment, the anode may be a solid lithium layer, and a current collector may be coupled to the anode. Additionally, the jelly roll may be wound using one or more mandrels.

In another embodiment, a top surface of the jelly roll may be not in contact with a top lid of the cylindrical shell. Additionally, a bottom surface of the jelly roll may be at least partially in contact with a negative contact surface of the cylindrical shell. Further, a casing of the battery may be formed from one or more of aluminum or steel. In one embodiment, a positive terminal of the battery may be welded to a current collector electrically coupled to the cathode, and a negative contact surface may be welded to a current collector coupled to the anode.

In another embodiment, the anode may comprise an alloy selected to surpass a minimum shear strength, where the minimum shear strength surpasses 50 N/cm2 Additionally, the anode may be an alloy selected to surpass a minimum mechanical strength, where the minimum mechanical strength surpasses 160 N/cm2.

In another embodiment, at least one of the first separator or the second separator may be configured for ion flow. Additionally, the battery may further comprise an inlay comprising copper, where the inlay may be one of a vertical strip or a horizontal strip. The vertical strip may be stamped into the anode, and the horizontal strip may be inlayed within the anode.

In another embodiment, the anode may function as a current collector. Additionally, the anode may consist of pure lithium, and at least one of the first separator or the second separator include a carrier film, where the carrier film increases the tensile strength of the pure lithium. Further, the anode may be a lithium alloy, and at least one of the first separator or the second separator may not include a carrier film.

In another embodiment, the cylindrical shell may have a diameter in a range from approximately 18.4 millimeter (mm) to approximately 18.6 mm and a length in a range from approximately 65.1 mm to approximately 65.3 mm. Additionally, the cylindrical shell may be congruent with an 18560 cell. Further, at least one of the anode or the cathode may not include a tab.

In another embodiment, the freestanding assembly may be a substrate-less electrode. Additionally, the freestanding assembly is a copper-free assembly. Further, the anode may lack a separate layer for a current collector. For example, the may lithium function as a current collector.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a side perspective of a cylindrical cell 200 with a free standing lithium anode, in accordance with one embodiment. As an option, the cylindrical cell 200 may be implemented in the context of any one or more of the embodiments set forth in any previous and/or subsequent figure(s) and/or description thereof. Of course, however, the cylindrical cell 200 may be implemented in the context of any desired environment. Further, the aforementioned definitions may equally apply to the description below.

As shown, the side perspective of the cylindrical cell 200 may take the form of a jelly roll style construction comprised of a compressed lithium anode material 204 adhered to a separator compound 202, which may be rolled upon itself repeatedly starting from a central collector structure. A first tab 206 and a second tab 208 may correspond with a positive and negative terminal of the battery.

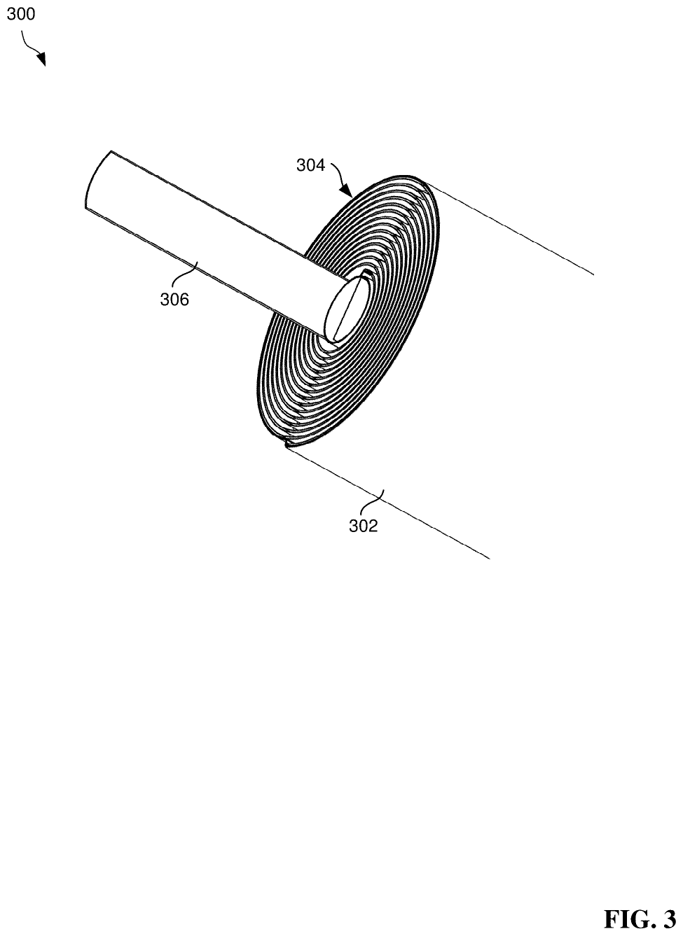

FIG. 3 illustrates a close-up perspective of a cylindrical cell 300 with a free standing lithium anode, in accordance with one embodiment. As an option, the cylindrical cell 300 may be implemented in the context of any one or more of the embodiments set forth in any previous and/or subsequent figure(s) and/or description thereof. Of course, however, the cylindrical cell 300 may be implemented in the context of any desired environment. Further, the aforementioned definitions may equally apply to the description below.

As shown, the close-up perspective of the cylindrical cell 300 may take the form of a jelly roll style construction comprised of a compressed lithium anode material 304 adhered to a separator compound 302, which may be rolled upon itself repeatedly starting from a central collector structure. Additionally, a tab 306 to conduct the electric charge is displayed.

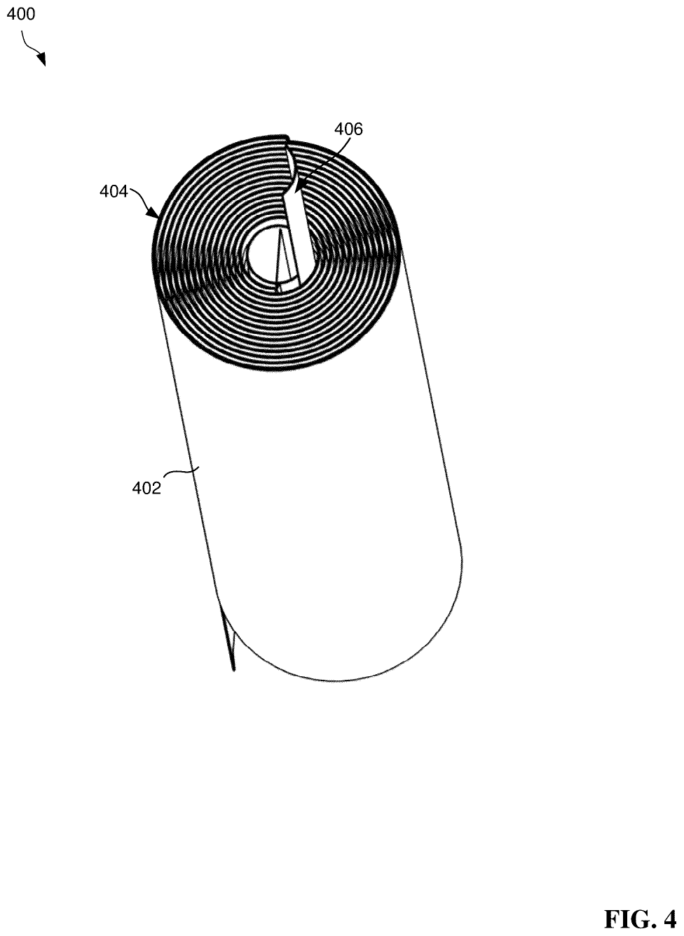

FIG. 4 illustrates a top-down perspective of a cylindrical cell 400 with a free standing lithium anode, in accordance with one embodiment. As an option, the cylindrical cell 400 may be implemented in the context of any one or more of the embodiments set forth in any previous and/or subsequent figure(s) and/or description thereof. Of course, however, the cylindrical cell 400 may be implemented in the context of any desired environment. Further, the aforementioned definitions may equally apply to the description below.

As shown, the top-down perspective of the cylindrical cell 400 may take the form of a jelly roll style construction comprised of a compressed lithium anode material 404 adhered to a separator compound 402, which may be rolled upon itself repeatedly starting from a central collector structure. Additionally, a tab 406 to conduct the electric charge is displayed.

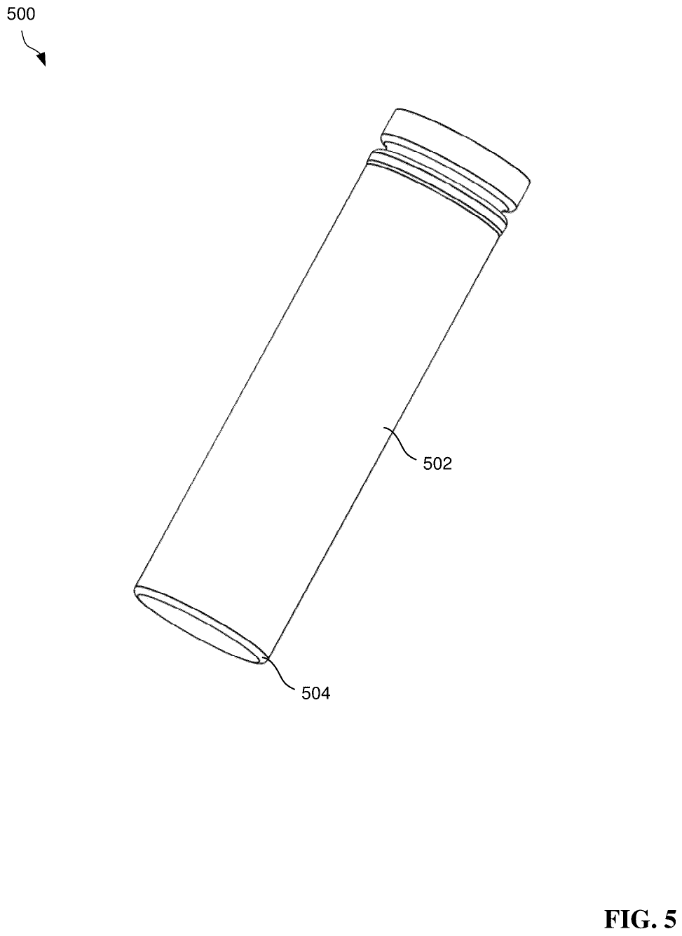

FIG. 5 illustrates a case 500 for a cylindrical cell with a free standing lithium anode, in accordance with one embodiment. As an option, the case 500 may be implemented in the context of any one or more of the embodiments set forth in any previous and/or subsequent figure(s) and/or description thereof. Of course, however, the case 500 may be implemented in the context of any desired environment. Further, the aforementioned definitions may equally apply to the description below.

As shown, the case 500 for the cylindrical cell may comprise a protective, non-conductive container 502 with a positive terminal 504 capping one end of the container 502. The case 500 may be used to house the cylindrical cell battery discussed herein.

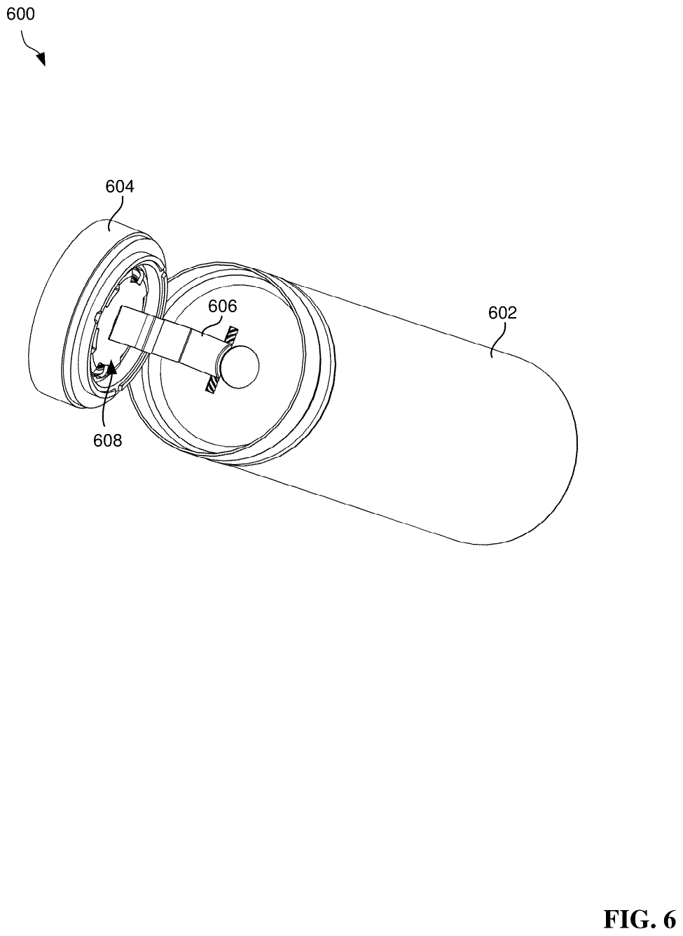

FIG. 6 illustrates an assembled cylindrical cell 600 with a free standing lithium anode, in accordance with one embodiment. As an option, the assembled cylindrical cell 600 may be implemented in the context of any one or more of the embodiments set forth in any previous and/or subsequent figure(s) and/or description thereof. Of course, however, the assembled cylindrical cell 600 may be implemented in the context of any desired environment. Further, the aforementioned definitions may equally apply to the description below.

As shown, the assembled cylindrical cell 600 may comprise a protective, non-conductive container 602. A tab 606 may protrude outside of the container 602 and be connected directly to the cylindrical cell. In addition, the tab 606 may be welded, or otherwise affixed, to a terminal 608 of a top cap 604. Further, the top cap 604 may encompass a current collector and may fully enclose the container 602 at one end.

In one embodiment, the tab 606 may be comprised of a copper or nickel construct. In another embodiment, the tab 606 may be comprised of other conductive materials including, but not limited to, brass.

FIG. 7 illustrates an assembled cylindrical cell 700 with a free standing lithium anode, in accordance with one embodiment. As an option, the assembled cylindrical cell 700 may be implemented in the context of any one or more of the embodiments set forth in any previous and/or subsequent figure(s) and/or description thereof. Of course, however, the assembled cylindrical cell 700 may be implemented in the context of any desired environment. Further, the aforementioned definitions may equally apply to the description below.

As shown, the assembled cylindrical cell 700 may comprise a protective, non-conductive container 702 out of which a tab 706 (connected to a cylindrical cell battery) may protrude. In addition, the tab 706 may be welded, or otherwise affixed, to a current collector 708. Further, a top cap 704 may encompass the current collector 708 and may fully enclose the container 702 one end.

FIG. 8 illustrates a jelly roll configuration 800 for a cylindrical cell with a free standing lithium anode, in accordance with one embodiment. As an option, the jelly roll configuration 800 may be implemented in the context of any one or more of the embodiments set forth in any previous and/or subsequent figure(s) and/or description thereof. Of course, however, the jelly roll configuration 800 may be implemented in the context of any desired environment. Further, the aforementioned definitions may equally apply to the description below.

As shown, the jelly roll configuration 800 may comprise an anode-and-cathode structure 802 in the form of a roll of lithium structure axiomatically separated from each successive layer by an adhered separator compound. As discussed herein, the separator may function as an insulator, and/or may allow for electron flow (between the cathode and anode, and visa versa).

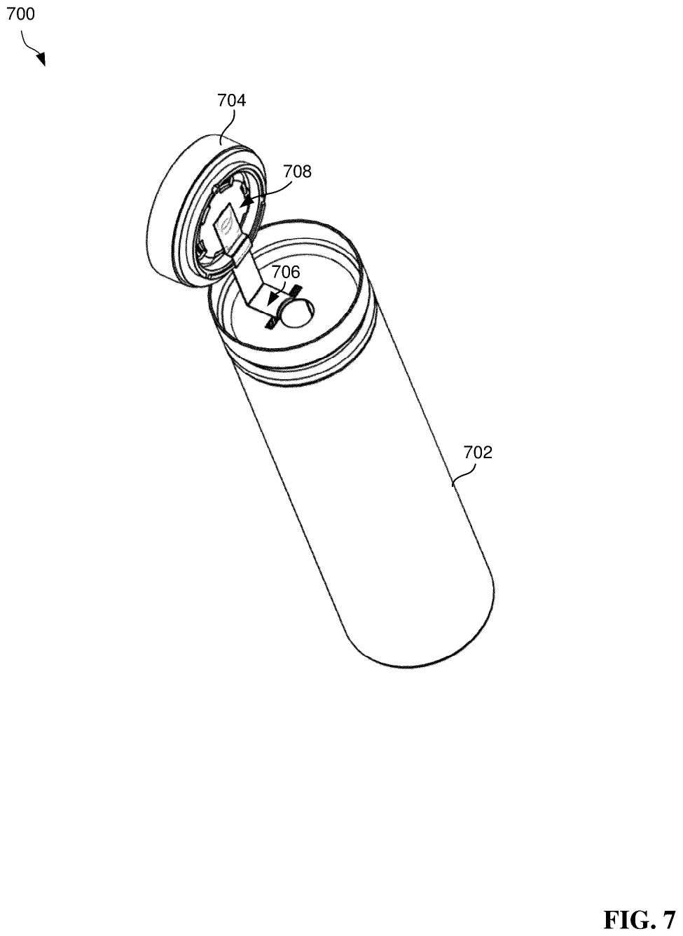

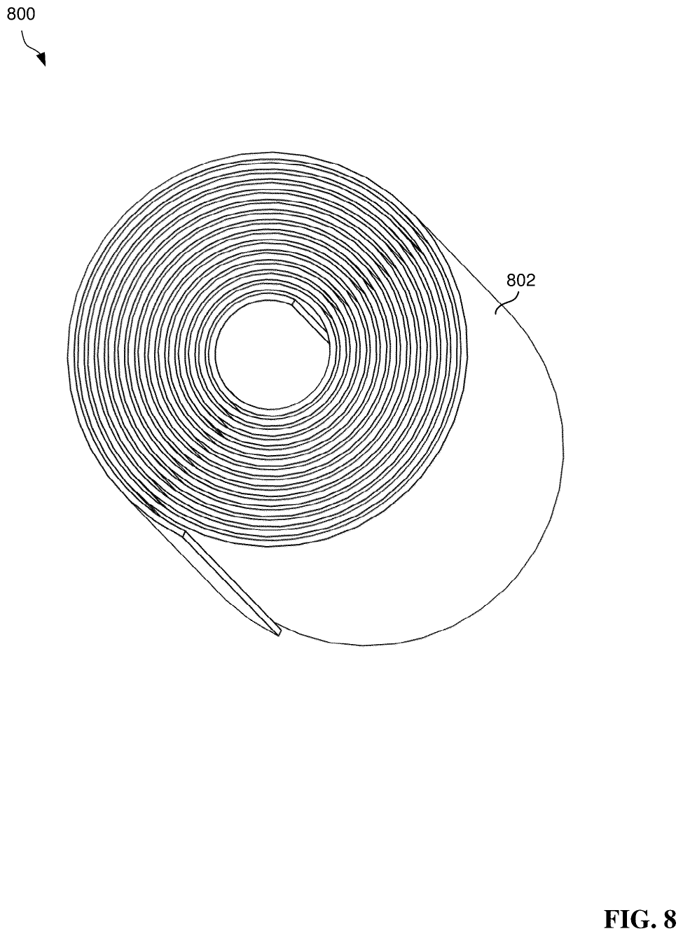

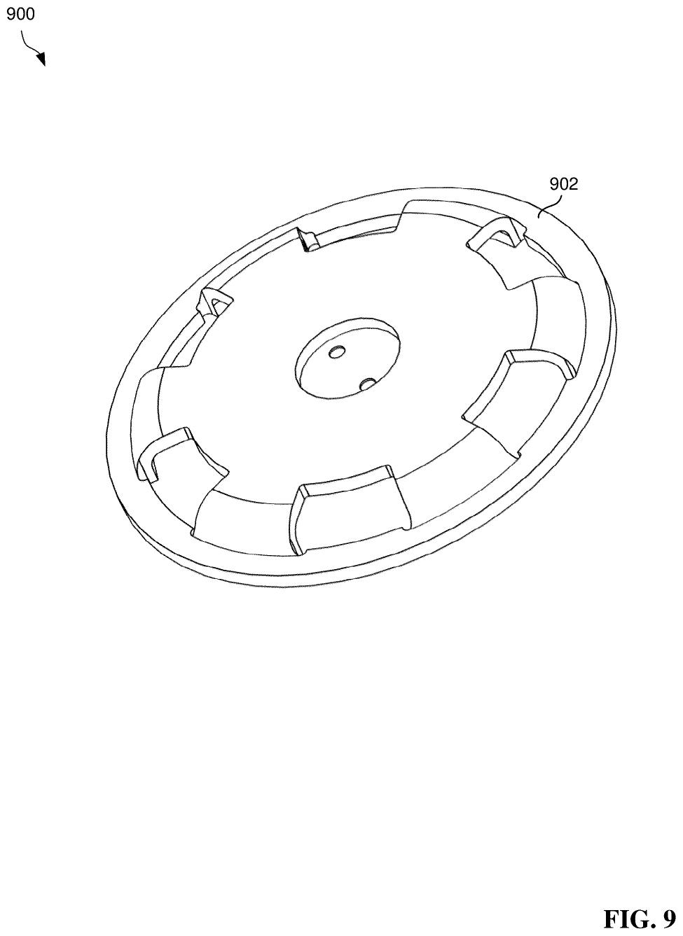

FIG. 9 illustrates a current collector 900 for a cylindrical cell with a free standing lithium anode, in accordance with one embodiment. As an option, the current collector 900 may be implemented in the context of any one or more of the embodiments set forth in any previous and/or subsequent figure(s) and/or description thereof. Of course, however, the current collector 900 may be implemented in the context of any desired environment. Further, the aforementioned definitions may equally apply to the description below.

As shown, the current collector 900 may comprise a housing 902 designed to remain in contact with the anode and cathode lithium structures within the cylindrical battery construction. Additionally, within the context of the assembled cylindrical cell 700, the current collector 900 may be, in one embodiment, located on the bottom-most component of the case structure (i.e. below the cylindrical cell).

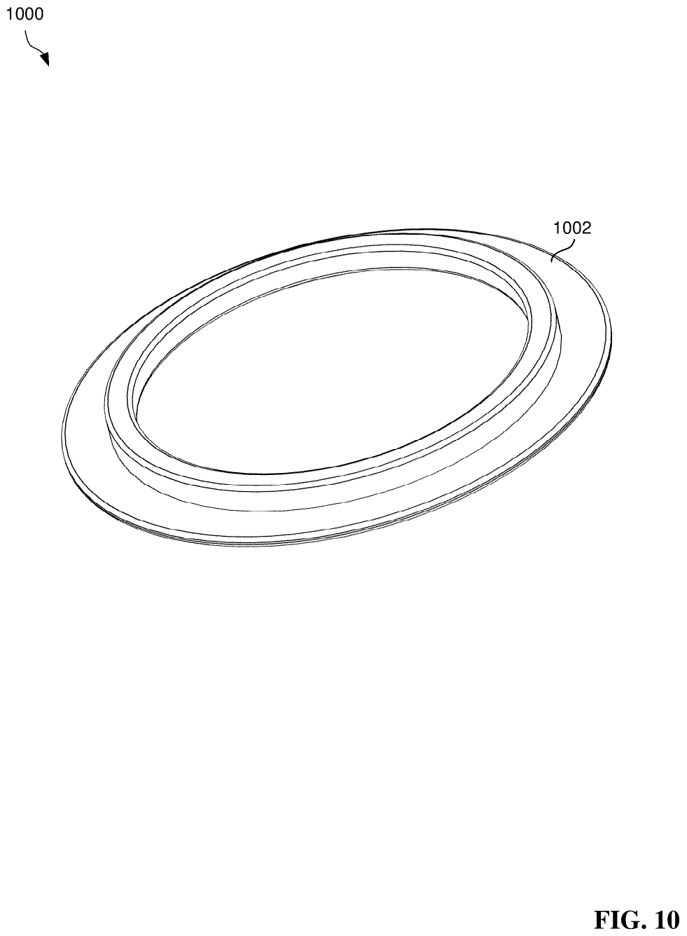

FIG. 10 illustrates a gasket 1000 for a cylindrical cell with a free standing lithium anode, in accordance with one embodiment. As an option, the gasket 1000 may be implemented in the context of any one or more of the embodiments set forth in any previous and/or subsequent figure(s) and/or description thereof. Of course, however, the gasket 1000 may be implemented in the context of any desired environment. Further, the aforementioned definitions may equally apply to the description below.

As shown, the gasket 1000 may comprise a ring 1002 of non-conductive material, which may be installed on top of the current collector 900 in order to keep the edges of the current collector 900 from coming in direct contact with a side of a casing.

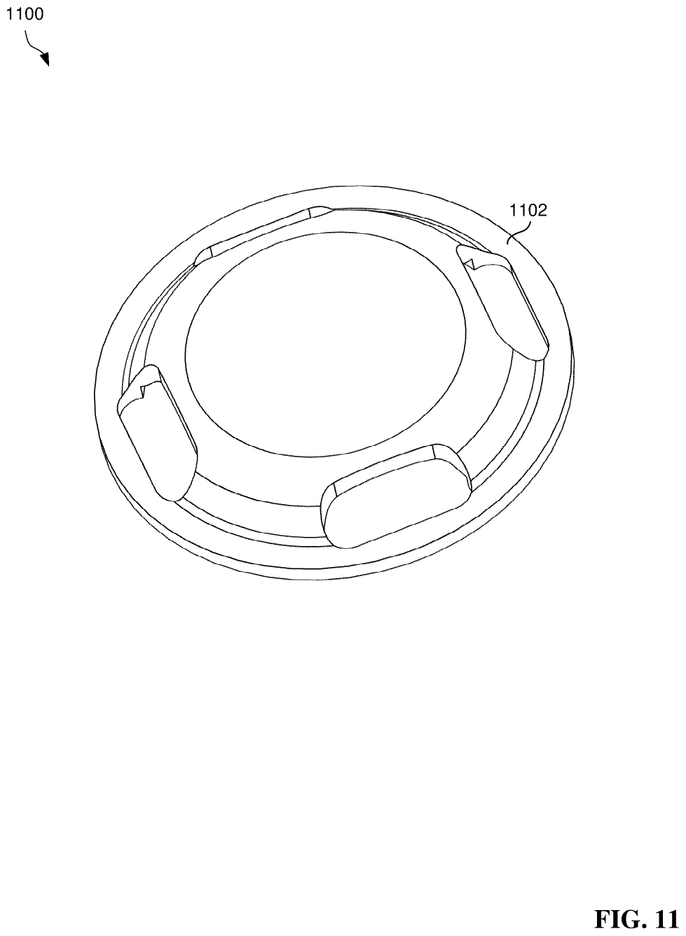

FIG. 11 illustrates a positive terminal 1100 for a cylindrical cell with a free standing lithium anode, in accordance with one embodiment. As an option, the positive terminal 1100 may be implemented in the context of any one or more of the embodiments set forth in any previous and/or subsequent figure(s) and/or description thereof. Of course, however, the positive terminal 1100 may be implemented in the context of any desired environment. Further, the aforementioned definitions may equally apply to the description below.

As shown, the positive terminal 1100 may comprise a conductive surface cap 1102 for the battery to enable electron flow for discharging and recharging of the battery cell during operation.

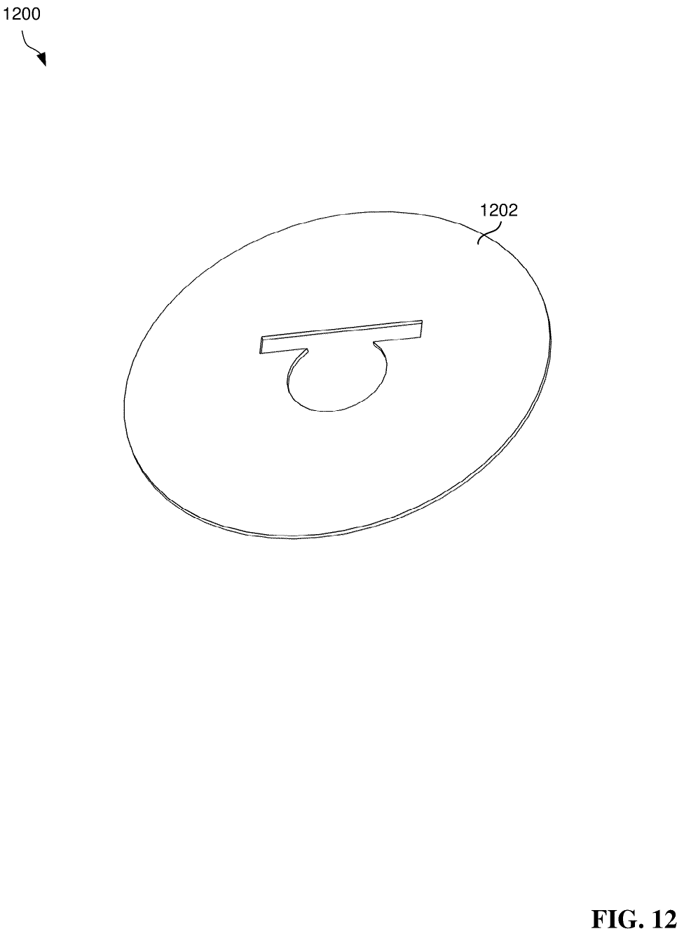

FIG. 12 illustrates a top insulator 1200 for a cylindrical cell with a free standing lithium anode, in accordance with one embodiment. As an option, the top insulator 1200 may be implemented in the context of any one or more of the embodiments set forth in any previous and/or subsequent figure(s) and/or description thereof. Of course, however, the top insulator 1200 may be implemented in the context of any desired environment. Further, the aforementioned definitions may equally apply to the description below.

As shown, the top insulator 1200 may comprise a circular structure 1202 with a port and slot carved into the center which may allow for connection to (contact with) the tab 706 and the inner contact structure to be connected to the current collector 708.

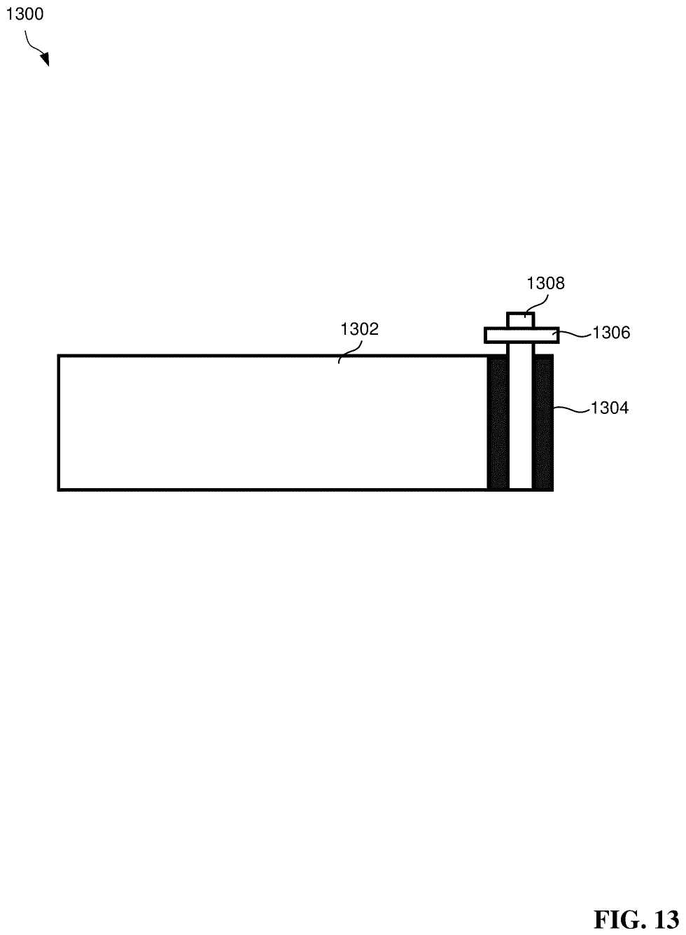

FIG. 13 illustrates a reduced copper-configured cylindrical cell 1300, in accordance with one embodiment. As an option, the reduced copper-configured cylindrical cell 1300 may be implemented in the context of any one or more of the embodiments set forth in any previous and/or subsequent figure(s) and/or description thereof. Of course, however, the reduced copper-configured cylindrical cell 1300 may be implemented in the context of any desired environment. Further, the aforementioned definitions may equally apply to the description below.

As shown, the reduced copper-configured cylindrical cell 1300 may comprise a roll 1302 of lithium encased in a pair of separator compounds with a copper stamping 1304 of the roll 1302. The copper stamping 1304 may facilitate consistent conductivity from the inner-most to outer-most layers of the roll 1302. Additionally, the reduced copper-configured cylindrical cell 1300 may comprise a contact structure 1308, around which the roll 1302 may be wrapped. In addition, the cylindrical cell 1300 may comprise a cell cap 1306 to enclose the exposed end of the jelly roll lithium-and-separator structure prior to final battery assembly.

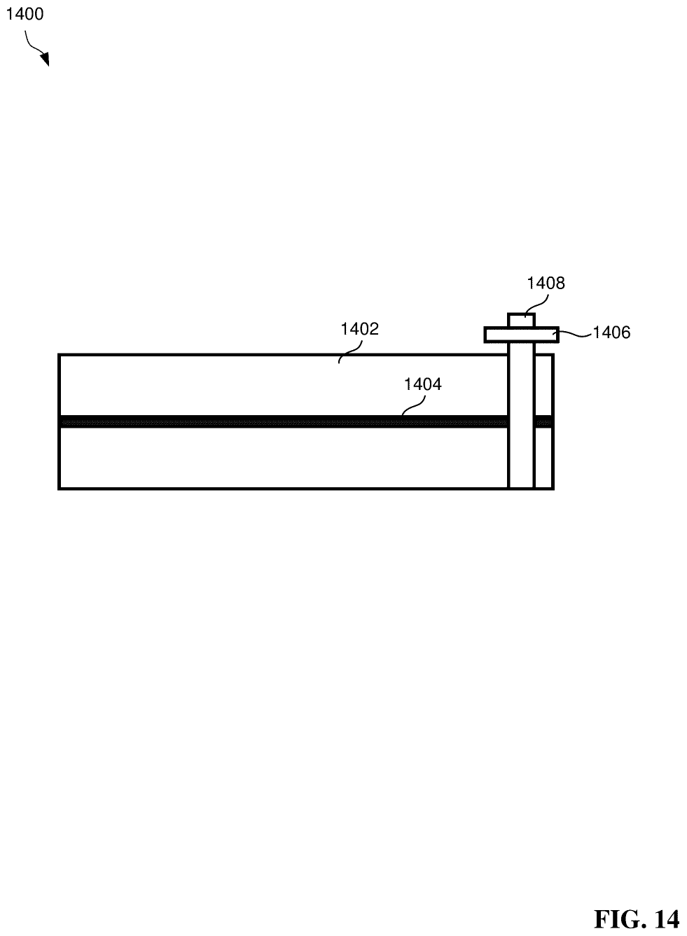

FIG. 14 illustrates a reduced copper-configured cylindrical cell 1400, in accordance with one embodiment. As an option, the reduced copper-configured cylindrical cell 1400 may be implemented in the context of any one or more of the embodiments set forth in any previous and/or subsequent figure(s) and/or description thereof. Of course, however, the reduced copper-configured cylindrical cell 1400 may be implemented in the context of any desired environment. Further, the aforementioned definitions may equally apply to the description below.

As shown, the reduced copper-configured cylindrical cell 1400 may comprise a roll 1402 of lithium encased in a pair of separator compounds with a copper strip 1404 integrated into the roll 1402 (similar in form of inlay banding). The copper strip, in one embodiment, may facilitate consistent conductivity from the inner-most to outer-most layers of the roll 1402. Additionally, the reduced copper-configured cylindrical cell 1400 may comprise a contact structure 1408, around which the roll 1402 may be wrapped. In addition, the cylindrical cell 1400 may comprise a cell cap 1406 to enclose the exposed end of the jelly roll lithium-and-separator structure prior to final battery assembly.

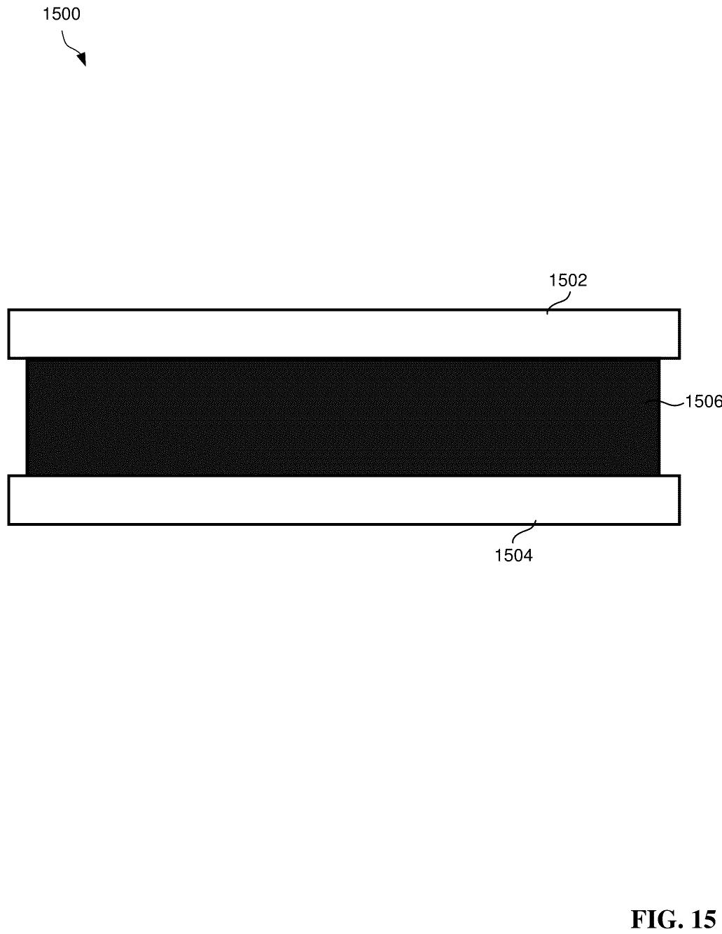

FIG. 15 illustrates a free standing lithium anode 1500, in accordance with one embodiment. As an option, the free standing lithium anode 1500 may be implemented in the context of any one or more of the embodiments set forth in any previous and/or subsequent figure(s) and/or description thereof. Of course, however, the free standing lithium anode 1500 may be implemented in the context of any desired environment. Further, the aforementioned definitions may equally apply to the description below.

As shown, the free standing lithium anode 1500 may comprise a strip of lithium material 1506 sandwiched between a first separator compound layer 1502 and a second separator compound layer 1504.

In one embodiment, the first separator compound layer 1502 and the second separator compound layer 1504 adhere to the lithium metal in a roll-to-roll process where two rolls of separator and one roll of lithium are fed into a single roll through a set of rollers which may then apply a predetermined amount of pressure (from 1 psi to 10 psi) on the separator-lithium-separator structure such that the separator is sufficiently adhered to the lithium on both sides.

In another embodiment, the first separator compound layer 1502 may provide tension relief along its x-, y-, and z-planes in an effort to prevent the separator-lithium-separator structure from shearing during manufacturing. In a related embodiment, the second separator compound layer 1504 may reduce modification of existing manufacturing processes due to the fact that the lithium layer would be prevented from coming into contact with potentially contaminated manufacturing surfaces, thus compromising the separator-lithium-separator structure even before battery construction.

In still another embodiment, the rolling or winding process that creates the jelly roll form of the free standing lithium anode 1500 may include increasing the relative tension (or “tightness”) of the rolled anode material as it naturally expands form the center, where less tension is required, to the outer-most layers, where the greatest tension is required to keep a uniform jelly roll structure throughout the lithium battery cell.

It is to be appreciated that if the strip of lithium material 1506 is pure lithium, the free standing lithium anode 1500 may be modified to include a carrier film for the lithium material. In the event, however, that the strip of lithium material 1506 is an alloy, then a carrier film may not be needed.

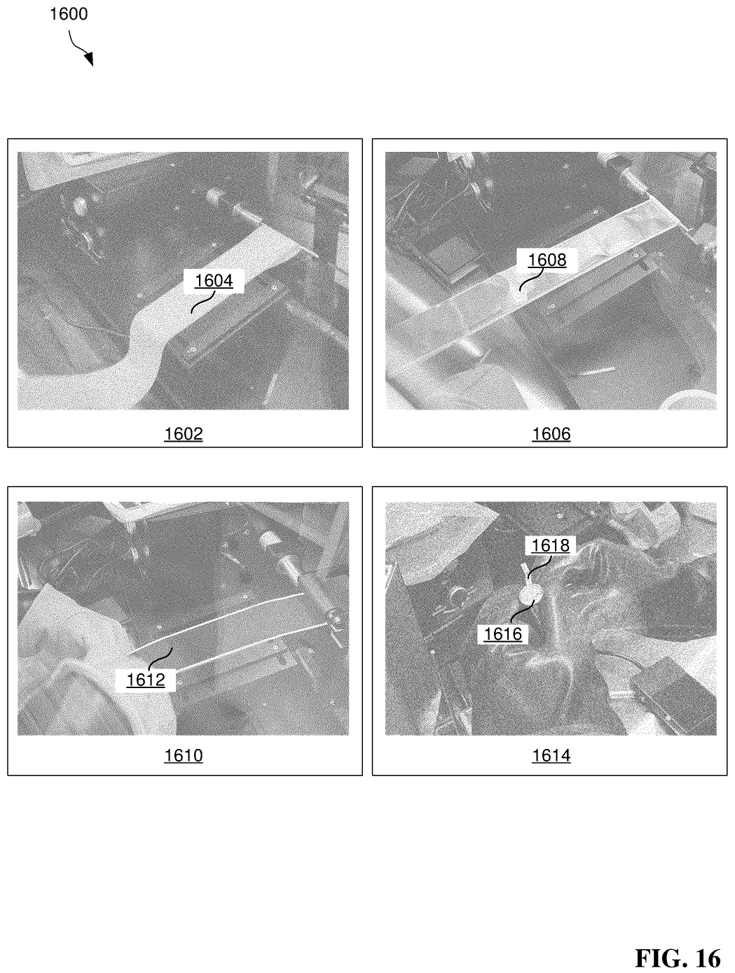

FIG. 16 illustrates production images 1600 for a cylindrical cell with a free standing lithium anode, in accordance with one embodiment. As an option, the production images 1600 may be implemented in the context of any one or more of the embodiments set forth in any previous and/or subsequent figure(s) and/or description thereof. Of course, however, the production images 1600 may be implemented in the context of any desired environment. Further, the aforementioned definitions may equally apply to the description below.

As shown, the production images 1600 for a battery assembly process may comprise a first assembly step 1602 wherein a separator layer 1604 may be set in position prior to first winding/wrapping process. Additionally, a second assembly step 1606 may be employed wherein a lithium structure 1608 is placed on top of the separator layer 1604. Further, a third assembly step 1610 may be performed wherein the last layer(s) 1612 of the wrapped separator-lithium-separator structure may be cut at a precise point to complete the jelly roll structure. In addition, a fourth assembly step 1614 may be completed where a connection tab 1618 is set apart from the jelly roll structure 1616. Further, in one embodiment, a first connection tab may be in contact with an anode, and a separate second connection tab may be in contact with a cathode. It is to be appreciated that the production images 1600 contained herein show a separation layer 1604 and the lithium structure 1608, which may include, as described herein, a single separation layer, an anode, a second separation layer, and a cathode.

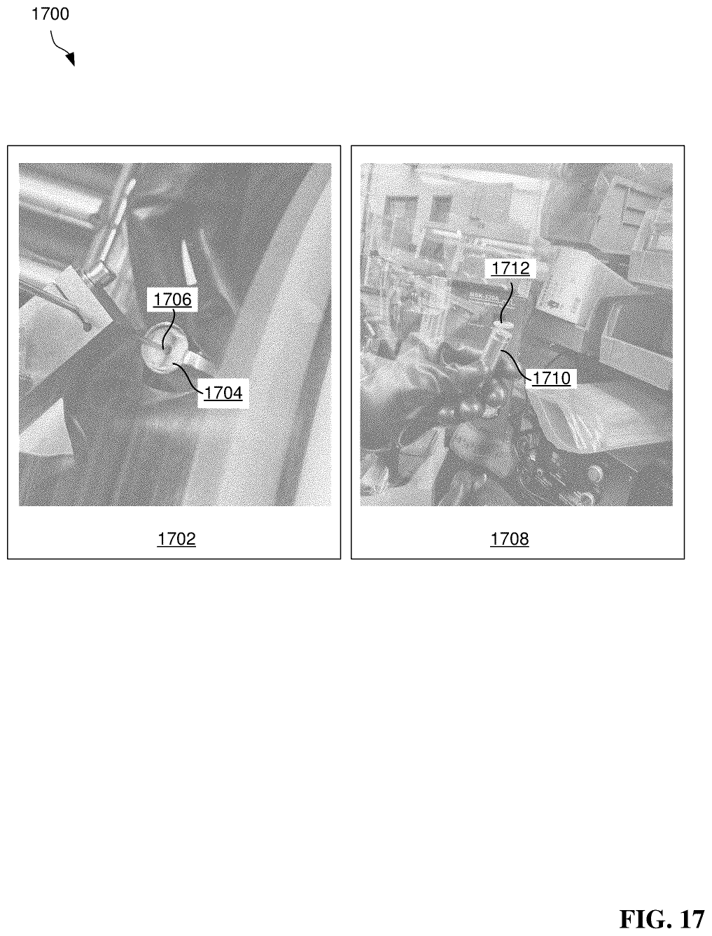

FIG. 17 illustrates production images 1700 for a cylindrical cell with a free standing lithium anode, in accordance with one embodiment. As an option, the production images 1700 may be implemented in the context of any one or more of the embodiments set forth in any previous and/or subsequent figure(s) and/or description thereof. Of course, however, the production images 1700 may be implemented in the context of any desired environment. Further, the aforementioned definitions may equally apply to the description below.

As shown, the production images 1700 for a battery assembly process may comprise a fifth assembly step 1702 (continuing from FIG. 16) wherein a battery casing insulator 1704 may be welded (or otherwise permanently affixed) to the positive terminal end of the lithium battery assembly with a connection tab 1706 left protruding and accessible for welding to a current collector. Additionally, a sixth assembly step 1708 may be completed where a positive current collector component 1712 may be welded (or otherwise permanently affixed) to an outer battery casing 1710.

In one embodiment, the current collector component 1712 may be comprised of nickel or other similar material for such purpose. In a related embodiment, the connection tab 1706 may be comprised of aluminum, which may be carefully folded over the battery casing insulator 1704 within the top battery assembly to prevent incorrect assembly when the top current collector component 1712 may be ultimately installed and affixed to the completed battery cell structure.

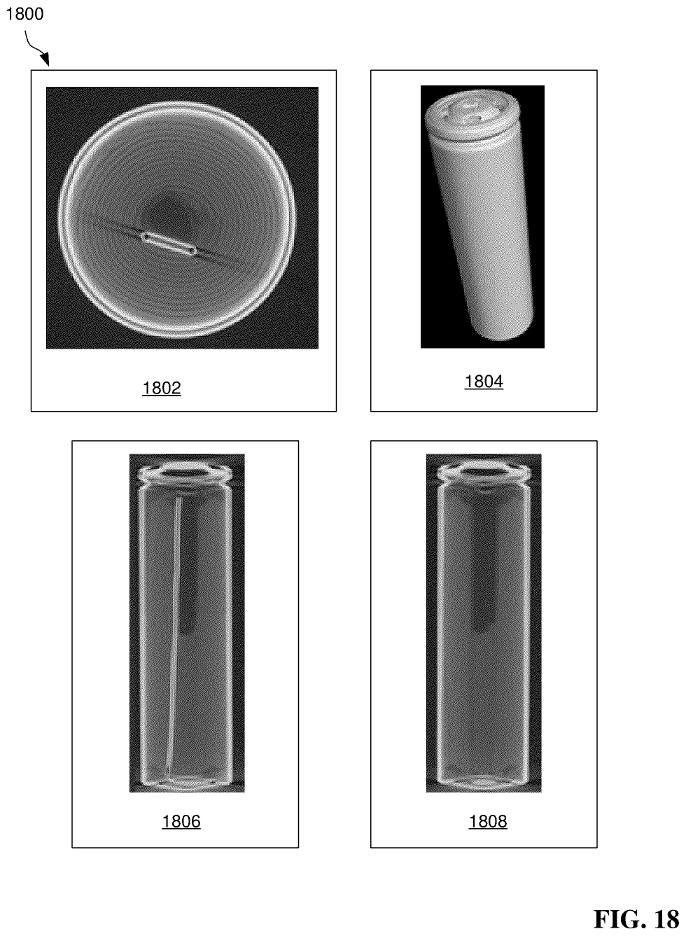

FIG. 18 illustrates computed tomography scans 1800 of a cylindrical cell with a free standing lithium anode, in accordance with one embodiment. As an option, the computed tomography scans 1800 may be implemented in the context of any one or more of the embodiments set forth in any previous and/or subsequent figure(s) and/or description thereof. Of course, however, the computed tomography scans 1800 may be implemented in the context of any desired environment. Further, the aforementioned definitions may equally apply to the description below.

As shown, the computed tomography (CT) scans 1800 may comprise a first CT scan 1802 displaying a cross section of the jelly roll structure of an assembled lithium battery. Additionally, a second CT scan 1804 may show a detailed image of the casing of an assembled lithium battery with its associated collector and connection tab within the assembled lithium battery. In addition, a third CT scan 1806 may show a portrait-oriented CT scan of the internal structure of the jelly roll including the associated collector and connection tab within the assembled lithium battery. Further, a fourth CT scan 1808 may show a portrait-oriented CT scan of the external structure of an assembled lithium battery.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

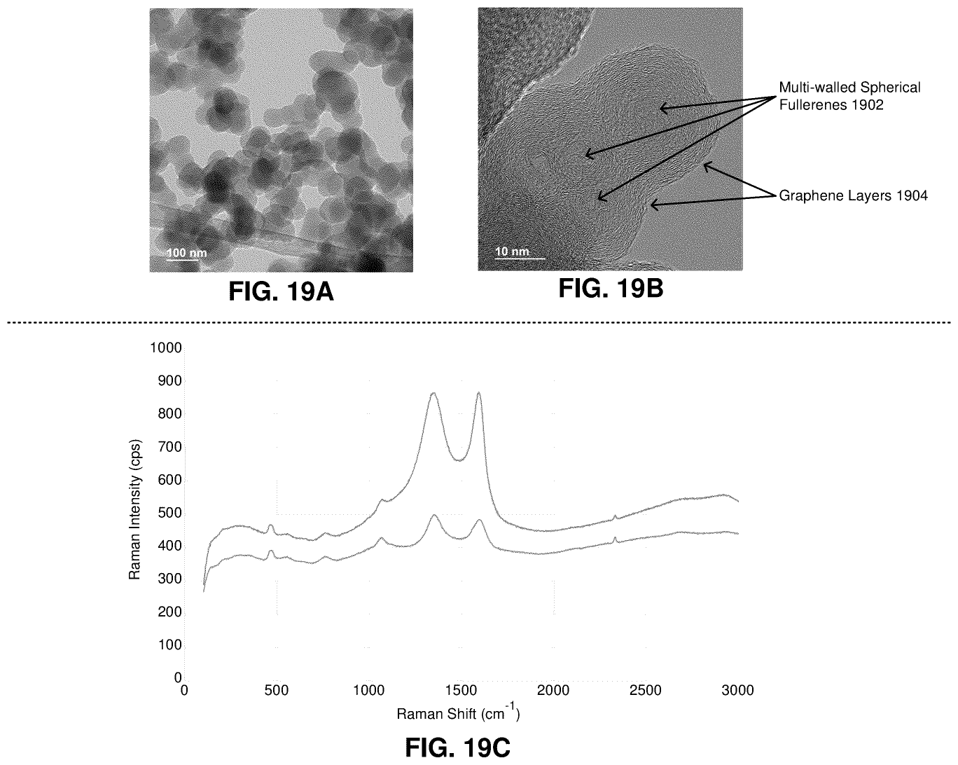

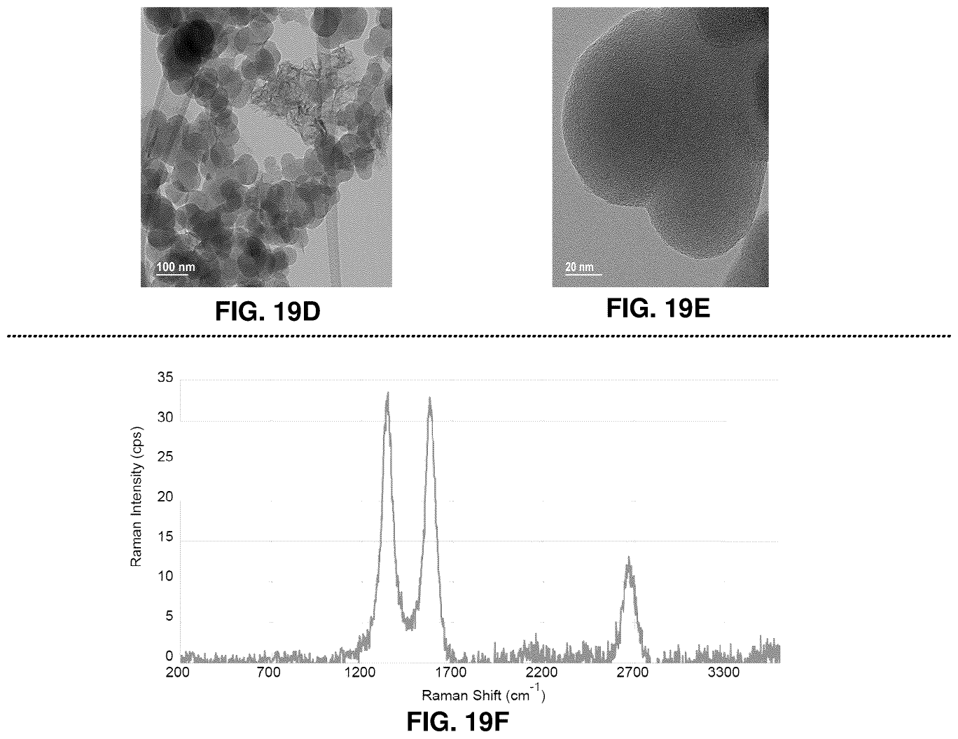

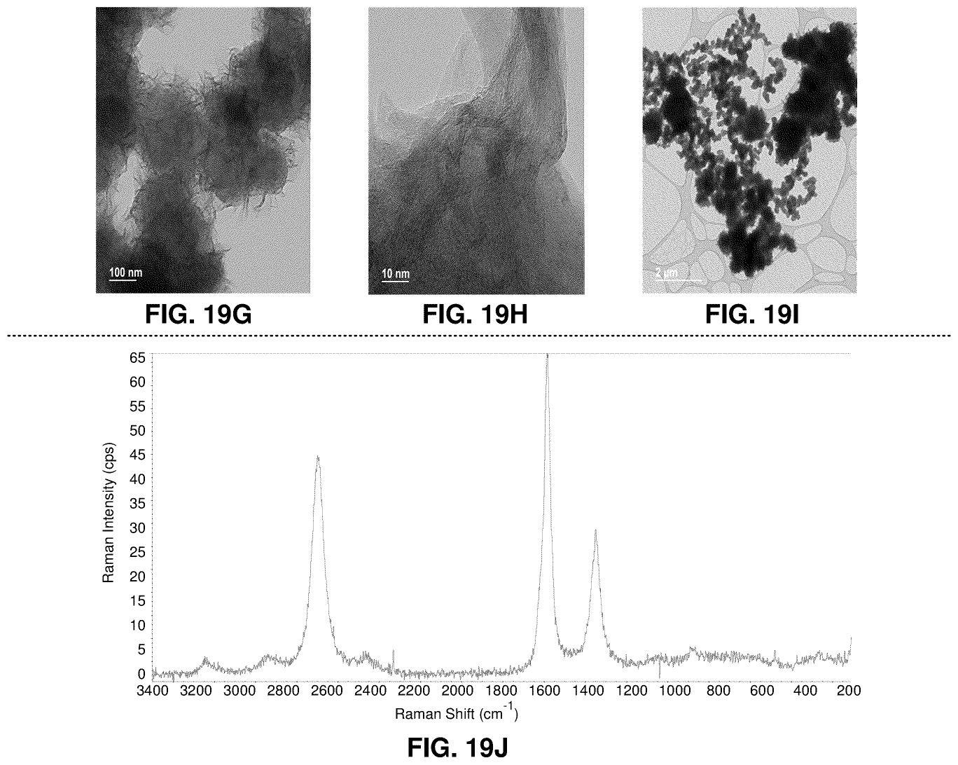

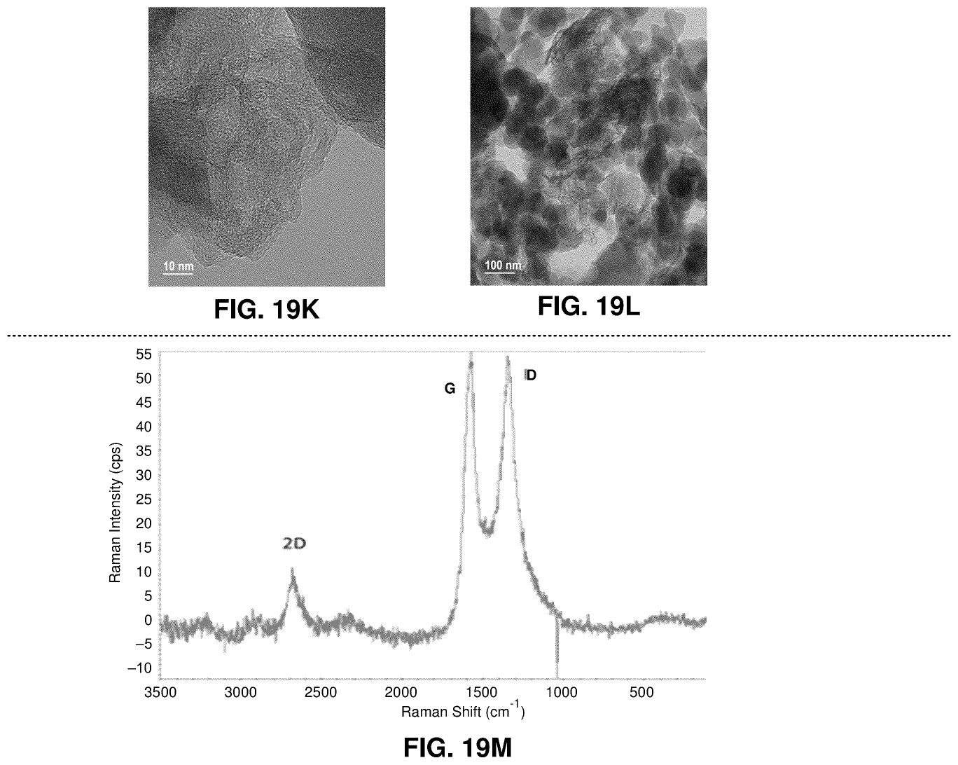

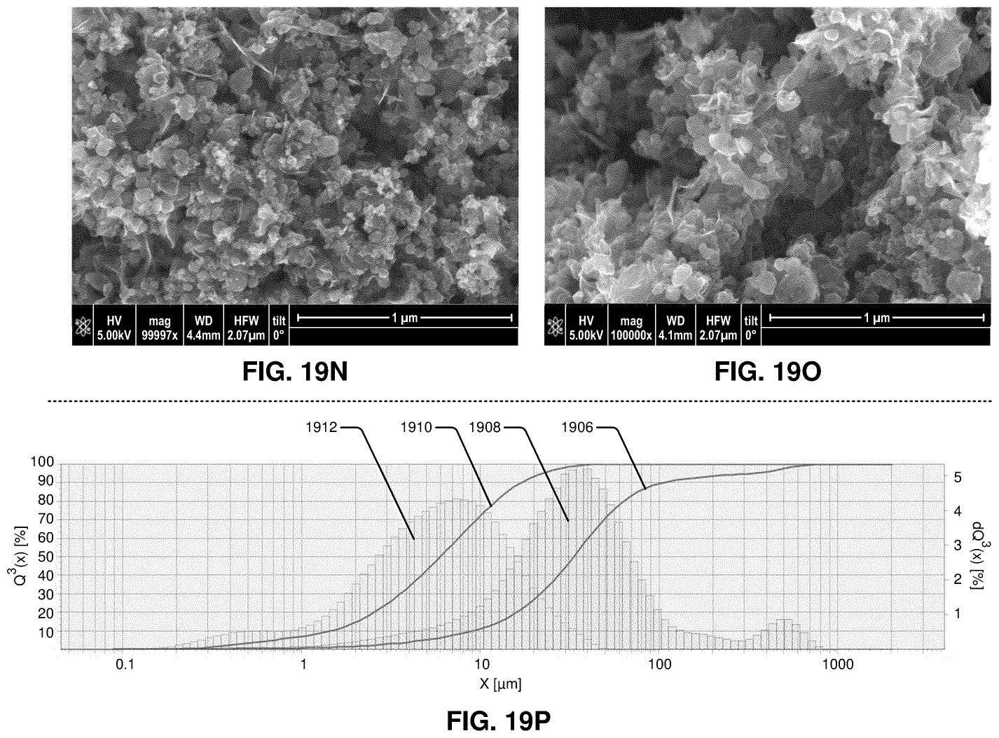

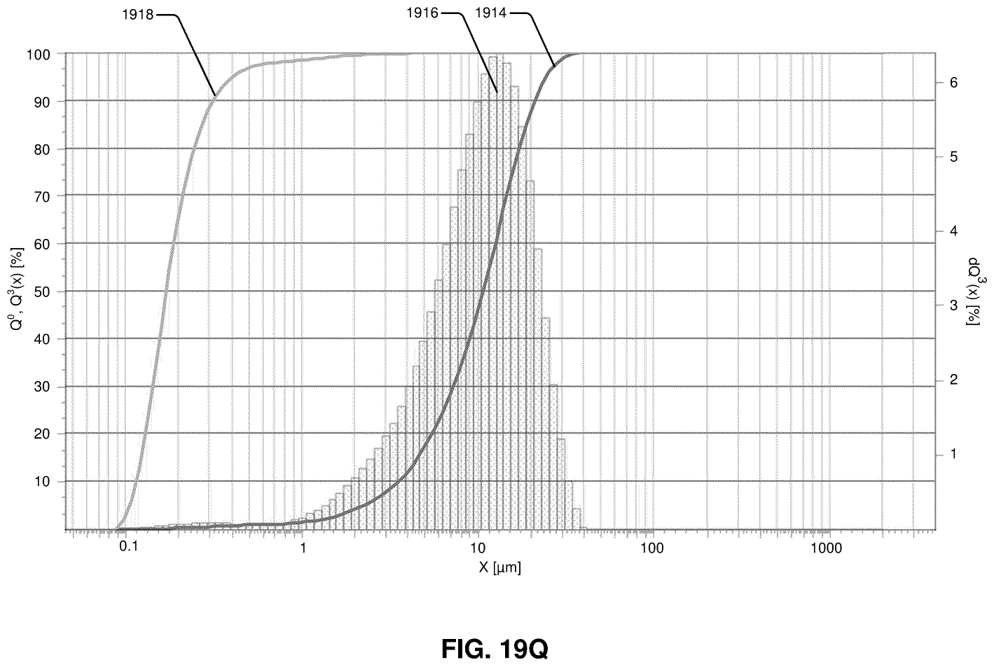

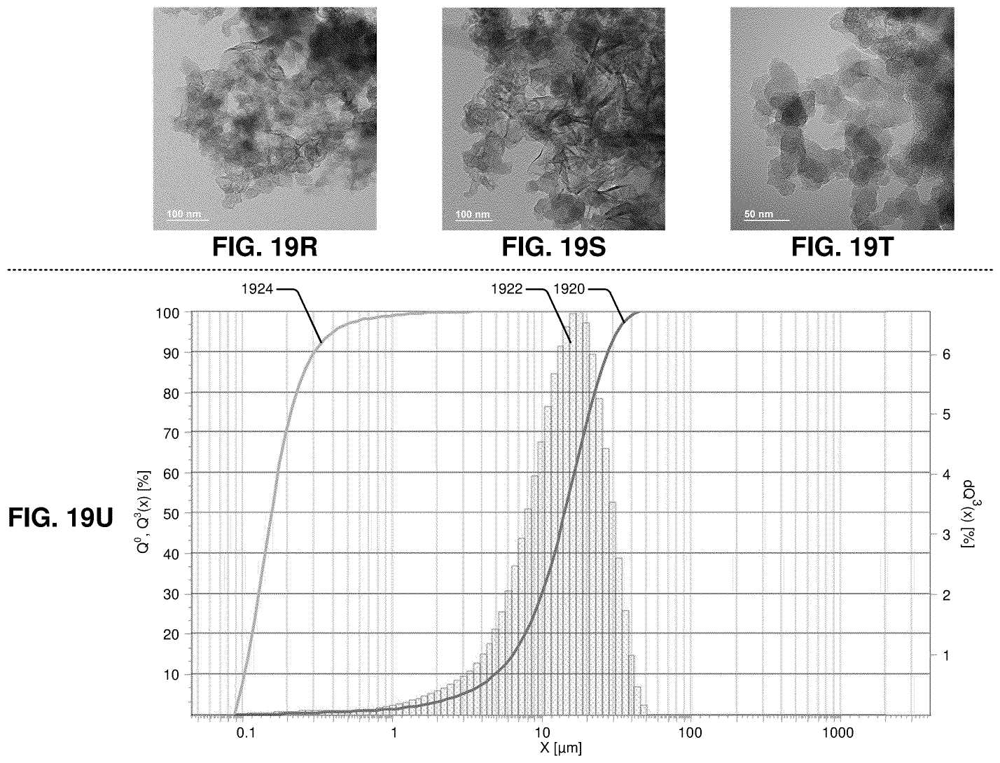

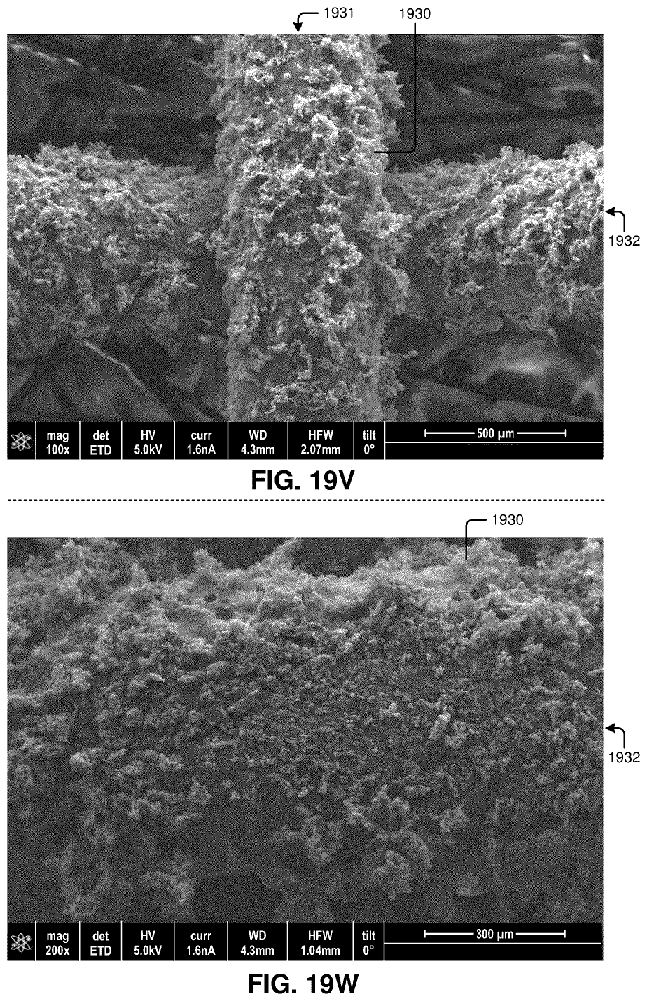

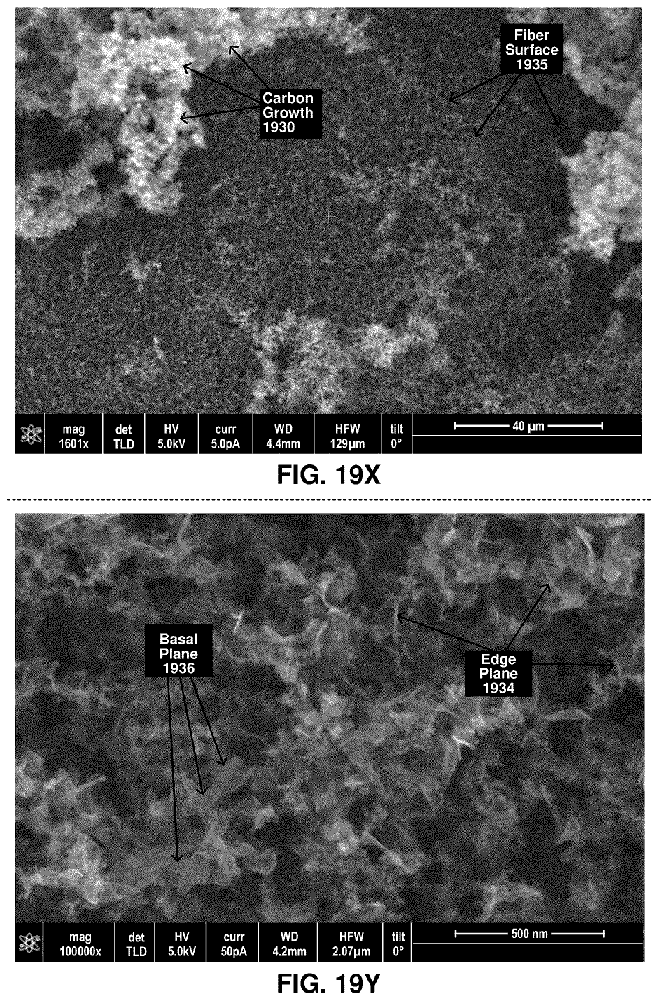

FIG. 19A through FIG. 19Y depict structured carbons, various carbon nanoparticles, various carbon-containing aggregates, and various three-dimensional carbon-containing structures that are grown over other materials, according to some embodiments of the present disclosure.

In some embodiments, the carbon nanoparticles and aggregates are characterized by a high “uniformity” (i.e., high mass fraction of desired carbon allotropes), a high degree of “order” (i.e., low concentration of defects), and/or a high degree of “purity” (i.e., low concentration of elemental impurities), in contrast to the lower uniformity, less ordered, and lower purity particles achievable with conventional systems and methods.

In some embodiments, the nanoparticles produced using the methods described herein contain multi-walled spherical fullerenes (MWSFs) or connected MWSFs and have a high uniformity (e.g., a ratio of graphene to MWSF from 20% to 80%), a high degree of order (e.g., a Raman signature with an I_{D}/I_{G} ratio from 0.95 to 1.05), and a high degree of purity (e.g., the ratio of carbon to other elements (other than hydrogen) is greater than 99.9%). In some embodiments, the nanoparticles produced using the methods described herein contain MWSFs or connected MWSFs, and the MWSFs do not contain a core composed of impurity elements other than carbon. In some cases, the particles produced using the methods described herein are aggregates containing the nanoparticles described above with large diameters (e.g., greater than 10 μm across).

Conventional methods have been used to produce particles containing multi-walled spherical fullerenes with a high degree of order, but the conventional methods lead to carbon products with a variety of shortcomings. For example, high temperature synthesis techniques lead to particles with a mixture of many carbon allotropes and therefore low uniformity (e.g., less than 20% fullerenes to other carbon allotropes) and/or small particle sizes (e.g., less than 1 μm, or less than 100 nm in some cases). Methods using catalysts lead to products including the catalyst elements and therefore have low purity (e.g., less than 95% carbon to other elements) as well. These undesirable properties also often lead to undesirable electrical properties of the resulting carbon particles (e.g., electrical conductivity of less than 1000 S/m).

In some embodiments, the carbon nanoparticles and aggregates described herein are characterized by Raman spectroscopy that is indicative of the high degree of order and uniformity of structure. In some embodiments, the uniform, ordered and/or pure carbon nanoparticles and aggregates described herein are produced using relatively high speed, low cost improved thermal reactors and methods, as described below. Additional advantages and/or improvements will also become apparent from the following disclosure.

In the present disclosure, the term “graphene” refers to an allotrope of carbon in the form of a two-dimensional, atomic-scale, hexagonal lattice in which one atom forms each vertex. The carbon atoms in graphene are sp²-bonded. Additionally, graphene has a Raman spectrum with two main peaks: a G-mode at approximately 1580 cm⁻¹ and a D-mode at approximately 1350 cm⁻¹ (when using a 532 nm excitation laser).

In the present disclosure, the term “fullerene” refers to a molecule of carbon in the form of a hollow sphere, ellipsoid, tube, or other shapes. Spherical fullerenes can also be referred to as Buckminsterfullerenes, or buckyballs. Cylindrical fullerenes can also be referred to as carbon nanotubes. Fullerenes are similar in structure to graphite, which is composed of stacked graphene sheets of linked hexagonal rings. Fullerenes may also contain pentagonal (or sometimes heptagonal) rings.

In the present disclosure, the term “multi-walled fullerene” refers to fullerenes with multiple concentric layers. For example, multi-walled nanotubes (MWNTs) contain multiple rolled layers (concentric tubes) of graphene. Multi-walled spherical fullerenes (MWSFs) contain multiple concentric spheres of fullerenes.

In the present disclosure, the term “nanoparticle” refers to a particle that measures from 1 nm to 989 nm. The nanoparticle can include one or more structural characteristics (e.g., crystal structure, defect concentration, etc.), and one or more types of atoms. The nanoparticle can be any shape, including but not limited to spherical shapes, spheroidal shapes, dumbbell shapes, cylindrical shapes, elongated cylindrical type shapes, rectangular prism shapes, disk shapes, wire shapes, irregular shapes, dense shapes (i.e., with few voids), porous shapes (i.e., with many voids), etc.

In the present disclosure, the term “aggregate” refers to a plurality of nanoparticles that are connected together by electrostatic forces (e.g., Van der Waals forces, London dispersion forces, dipole-dipole interactions, hydrogen bonding, etc.) by covalent bonds, by ionic bonds, by metallic bonds, or by other physical or chemical interactions. Aggregates can vary in size considerably, but in general are larger than about 500 nm.

In some embodiments, a carbon nanoparticle, as described herein, includes two or more connected multi-walled spherical fullerenes (MWSFs) and layers of graphene coating the connected MWSFs. In some embodiments, a carbon nanoparticle, as described herein, includes two or more connected multi-walled spherical fullerenes (MWSFs) and layers of graphene coating the connected MWSFs where the MWSFs do not contain a core composed of impurity elements other than carbon. In some embodiments, a carbon nanoparticle, as described herein, includes two or more connected multi-walled spherical fullerenes (MWSFs) and layers of graphene coating the connected MWSFs where the MWSFs do not contain a void (i.e., a space with no carbon atoms greater than approximately 0.5 nm, or greater than approximately 1 nm) at the center. In some embodiments, the connected MWSFs are formed of concentric, well-ordered spheres of sp²-hybridized carbon atoms, as contrasted with spheres of poorly-ordered, non-uniform, amorphous carbon particles.

In some embodiments, the nanoparticles containing the connected MWSFs have an average diameter in a range from 5 to 500 nm, or from 5 to 250 nm, or from 5 to 100 nm, or from 5 to 50 nm, or from 10 to 500 nm, or from 10 to 250 nm, or from 10 to 100 nm, or from 10 to 50 nm, or from 40 to 500 nm, or from 40 to 250 nm, or from 40 to 100 nm, or from 50 to 500 nm, or from 50 to 250 nm, or from 50 to 100 nm. Of course, nanoparticles containing connected MWSFs may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the carbon nanoparticles described herein form aggregates, wherein many nanoparticles aggregate together to form a larger unit. In some embodiments, a carbon aggregate includes a plurality of carbon nanoparticles. A diameter across the carbon aggregate is in a range from 10 to 500 μm, or from 50 to 500 μm, or from 100 to 500 μm, or from 250 to 500 μm, or from 10 to 250 μm, or from 10 to 100 μm, or from 10 to 50 μm. Of course, carbon aggregates may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the aggregate is formed from a plurality of carbon nanoparticles, as defined above. In some embodiments, aggregates contain connected MWSFs. In some embodiments, the aggregates contain connected MWSFs with a high uniformity metric (e.g., a ratio of graphene to MWSF from 20% to 80%), a high degree of order (e.g., a Raman signature with an I_{D}/I_{G} ratio from 0.95 to 1.05), and a high degree of purity (e.g., greater than 99.9% carbon).

One benefit of producing aggregates of carbon nanoparticles, particularly with diameters in the ranges described above, is that aggregates of particles greater than 10 μm are easier to collect than particles or aggregates of particles that are smaller than 500 nm. The ease of collection reduces the cost of manufacturing equipment used in the production of the carbon nanoparticles and increases the yield of the carbon nanoparticles. Additionally, particles greater than 10 μm in size pose fewer safety concerns compared to the risks of handling smaller nanoparticles, e.g., potential health and safety risks due to inhalation of the smaller nanoparticles. The lower health and safety risks, thus, further reduce the manufacturing cost.

In some embodiments, a carbon nanoparticle has a ratio of graphene to MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-MWSF ratio characterized by having any of the foregoing values or being within any of the foregoing exemplary ranges, or an average graphene-to-MWSF ratio characterized by having a value or being within a range between any of the foregoing exemplary ranges, without limitation and without departing from the scope of the presently described inventive concepts.

In some embodiments, a carbon nanoparticle has a ratio of graphene to connected MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to connected MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-connected MWSF ratio characterized by having any of the foregoing values or being within any of the foregoing exemplary ranges, or an average graphene-to-connected MWSF ratio characterized by having a value or being within a range between any of the foregoing exemplary ranges, without limitation and without departing from the scope of the presently described inventive concepts.

In some embodiments, Raman spectroscopy is used to characterize carbon allotropes to distinguish their molecular structures. For example, graphene can be characterized using Raman spectroscopy to determine information such as order/disorder, edge and grain boundaries, thickness, number of layers, doping, strain, and thermal conductivity. MWSFs have also been characterized using Raman spectroscopy to determine the degree of order of the MWSFs.

In some embodiments, Raman spectroscopy is used to characterize the structure of MWSFs or connected MWSFs. The main peaks in the Raman spectra are the G-mode and the D-mode. The G-mode is attributed to the vibration of carbon atoms in sp²-hybridized carbon networks, and the D-mode is related to the breathing of hexagonal carbon rings with defects. In some cases, defects may be present, yet may not be detectable in the Raman spectra. For example, if the presented crystalline structure is orthogonal with respect to the basal plane, the D-peak will show an increase. On the other hand, if presented with a perfectly planar surface that is parallel with respect to the basal plane, the D-peak will be zero.

When using 532 nm incident light, the Raman G-mode is typically at 1582 cm⁻¹ for planar graphite, however can be downshifted for MWSFs or connected MWSFs (e.g., down to 1565 cm⁻¹ or down to 1580 cm⁻¹). The D-mode is observed at approximately 1350 cm⁻¹ in the Raman spectra of MWSFs or connected MWSFs. The ratio of the intensities of the D-mode peak to G-mode peak (i.e., the I_{D}/I_{G}) is related to the degree of order of the MWSFs, where a lower I_{D}/I_{G} indicates a higher degree of order. An I_{D}/I_{G} near or below 1 indicates a relatively high degree of order, and an I_{D}/I_{G} greater than 1.1 indicates a lower degree of order.

In some embodiments, a carbon nanoparticle or a carbon aggregate containing MWSFs or connected MWSFs, as described herein, has a Raman spectrum with a first Raman peak at about 1350 cm⁻¹ and a second Raman peak at about 1580 cm⁻¹ when using 532 nm incident light. In some embodiments, the ratio of an intensity of the first Raman peak to an intensity of the second Raman peak (i.e., the I_{D}/I_{G}) for the nanoparticles or the aggregates described herein is in a range from 0.95 to 1.05, or from 0.9 to 1.1, or from 0.8 to 1.2, or from 0.9 to 1.2, or from 0.8 to 1.1, or from 0.5 to 1.5, or less than 1.5, or less than 1.2, or less than 1.1, or less than 1, or less than 0.95, or less than 0.9, or less than 0.8. Of course, carbon nanoparticles or aggregates including MWSFs or connected MWSFs may be characterized by a ratio of first and second Raman peak intensities having any of the foregoing values or being within any of the foregoing exemplary ranges, or a ratio of first and second Raman peak intensities characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high purity. In some embodiments, the carbon aggregate containing MWSFs or connected MWSFs has a ratio of carbon to metals of greater than 99.99%, or greater than 99.95%, or greater than 99.9%, or greater than 99.8%, or greater than 99.5%, or greater than 99%. In some embodiments, the carbon aggregate has a ratio of carbon to other elements of greater than 99.99%, or greater than 99.95%, or greater than 99.9%, or greater than 99.5%, or greater than 99%, or greater than 90%, or greater than 80%, or greater than 70%, or greater than 60%. In some embodiments, the carbon aggregate has a ratio of carbon to other elements (except for hydrogen) of greater than 99.99%, or greater than 99.95%, or greater than 99.9%, or greater than 99.8%, or greater than 99.5%, or greater than 99%, or greater than 90%, or greater than 80%, or greater than 70%, or greater than 60%. Of course, carbon aggregates including MWSFs or connected MWSFs may be characterized by a ratio of carbon to metal having any of the foregoing values or being within any of the foregoing exemplary ranges, or a ratio of carbon to metal having value or being within a range between any of the foregoing exemplary ranges, without limitation and without departing from the scope of the presently described inventive concepts.

In some embodiments, a carbon aggregate containing MWSFs or connected MWSFs, as defined above, has a high specific surface area. In some embodiments, the carbon aggregate has a Brunauer, Emmett and Teller (BET) specific surface area from 10 to 200 m²/g, or from 10 to 100 m²/g, or from 10 to 50 m²/g, or from 50 to 200 m²/g, or from 50 to 100 m²/g, or from 10 to 1000 m²/g. Of course, carbon aggregates including MWSFs or connected MWSFs may be characterized by a BET specific surface area having any of the foregoing values or being within any of the foregoing exemplary ranges, or a BET specific surface area characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high electrical conductivity. In some embodiments, a carbon aggregate containing MWSFs or connected MWSFs, as defined above, is compressed into a pellet and the pellet has an electrical conductivity greater than 500 S/m, or greater than 1000 S/m, or greater than 2000 S/m, or greater than 3000 S/m, or greater than 4000 S/m, or greater than 5000 S/m, or greater than 10000 S/m, or greater than 20000 S/m, or greater than 30000 S/m, or greater than 40000 S/m, or greater than 50000 S/m, or greater than 60000 S/m, or greater than 70000 S/m, or from 500 S/m to 100000 S/m, or from 500 S/m to 1000 S/m, or from 500 S/m to 10000 S/m, or from 500 S/m to 20000 S/m, or from 500 S/m to 100000 S/m, or from 1000 S/m to 10000 S/m, or from 1000 S/m to 20000 S/m, or from 10000 to 100000 S/m, or from 10000 S/m to 80000 S/m, or from 500 S/m to 10000 S/m. Of course, carbon aggregates including MWSFs or connected MWSFs may be characterized by an electrical conductivity having any of the foregoing values or being within any of the foregoing exemplary ranges, or an electrical conductivity characterized by having a value or being within a range between any of the foregoing exemplary ranges, without limitation and without departing from the scope of the presently described inventive concepts.

In some cases, the density of the pellet is approximately 1 g/cm³, or approximately 1.2 g/cm³, or approximately 1.5 g/cm³, or approximately 2 g/cm³, or approximately 2.2 g/cm³, or approximately 2.5 g/cm³, or approximately 3 g/cm³. Of course, pellets may be characterized by a density having any of the foregoing values or being within any of the foregoing exemplary ranges, or a density having a value or being within a range between any of the foregoing exemplary ranges, without limitation and without departing from the scope of the presently described inventive concepts.

Additionally, tests have been performed in which compressed pellets of the carbon aggregate materials have been formed with compressions of 2000 psi and 12000 psi and with annealing temperatures of 800° C. and 1000° C. The higher compression and/or the higher annealing temperatures generally result in pellets with a higher degree of electrical conductivity, including in the range of 12410.0 S/m to 13173.3 S/m.

### High Purity Carbon Allotropes Produced Using Thermal Processing Systems

In some embodiments, the carbon nanoparticles and aggregates described herein are produced using thermal reactors and methods, such as any appropriate thermal reactor and/or method. Further details pertaining to thermal reactors and/or methods of use can be found in U.S. Pat. No. 9,862,602, issued Jan. 9, 2018, titled “CRACKING OF A PROCESS GAS”, which is hereby incorporated by reference in its entirety. Additionally, precursors (e.g., including methane, ethane, propane, butane, and natural gas) can be used with the thermal reactors to produce the carbon nanoparticles and the carbon aggregates described herein.

In some embodiments, the carbon nanoparticles and aggregates described herein are produced using the thermal reactors with gas flow rates from 1 slm to 10 slm, or from 0.1 slm to 20 slm, or from 1 slm to 5 slm, or from 5 slm to 10 slm, or greater than 1 slm, or greater than 5 slm. In some embodiments, the carbon nanoparticles and aggregates described herein are produced using the thermal reactors with gas resonance times from 0.1 seconds to 30 seconds, or from 0.1 seconds to 10 seconds, or from 1 seconds to 10 seconds, or from 1 seconds to 5 seconds, from 5 seconds to 10 seconds, or greater than 0.1 seconds, or greater than 1 seconds, or greater than 5 seconds, or less than 30 seconds. Of course, carbon nanoparticles and aggregates may be produced using thermal reactors with gas flow rates having any of the foregoing values or being within any of the foregoing exemplary ranges, or gas flow rates having a value or being within a range between any of the foregoing exemplary ranges, without limitation and without departing from the scope of the presently described inventive concepts.

In some embodiments, the carbon nanoparticles and aggregates described herein are produced using the thermal reactors with production rates from 10 g/hr to 200 g/hr, or from 30 g/hr to 200 g/hr, or from 30 g/hr to 100 g/hr, or from 30 g/hr to 60 g/hr, or from 10 g/hr to 100 g/hr, or greater than 10 g/hr, or greater than 30 g/hr, or greater than 100 g/hr. Of course, carbon nanoparticles and aggregates may be produced using thermal reactors with production rates having any of the foregoing values or being within any of the foregoing exemplary ranges, or production rates having a value or being within a range between any of the foregoing exemplary ranges, without limitation and without departing from the scope of the presently described inventive concepts.

In some embodiments, thermal reactors or other cracking apparatuses and thermal reactor methods or other cracking methods can be used for refining, pyrolizing, dissociating or cracking feedstock process gases into its constituents to produce the carbon nanoparticles and the carbon aggregates described herein, as well as other solid and/or gaseous products (e.g., hydrogen gas and/or lower order hydrocarbon gases). The feedstock process gases generally include, for example, hydrogen gas (H₂), carbon dioxide (CO₂), C₁ to C₁₀ hydrocarbons, aromatic hydrocarbons, and/or other hydrocarbon gases such as natural gas, methane, ethane, propane, butane, isobutane, saturated/unsaturated hydrocarbon gases, ethene, propene, etc., and mixtures thereof. The carbon nanoparticles and the carbon aggregates can include, for example, multi-walled spherical fullerenes (MWSFs), connected MWSFs, carbon nanospheres, graphene, graphite, highly ordered pyrolytic graphite, single-walled nanotubes, multi-walled nanotubes, other solid carbon products, and/or the carbon nanoparticles and the carbon aggregates described herein.

Some embodiments for producing the carbon nanoparticles and the carbon aggregates described herein include thermal cracking methods that use, for example, an elongated longitudinal heating element optionally enclosed within an elongated casing, housing or body of a thermal cracking apparatus. The body generally includes, for example, one or more tubes or other appropriate enclosures made of stainless steel, titanium, graphite, quartz, or the like. In some embodiments, the body of the thermal cracking apparatus is generally cylindrical in shape with a central elongate longitudinal axis arranged vertically and a feedstock process gas inlet at or near a top of the body. The feedstock process gas flows longitudinally down through the body or a portion thereof. In the vertical configuration, both gas flow and gravity assist in the removal of the solid products from the body of the thermal cracking apparatus.

The heating element generally includes, for example, a heating lamp, one or more resistive wires or filaments (or twisted wires), metal filaments, metallic strips or rods, and/or other appropriate thermal radical generators or elements that can be heated to a specific temperature (i.e., a molecular cracking temperature) sufficient to thermally crack molecules of the feedstock process gas. The heating element is generally disposed, located or arranged to extend centrally within the body of the thermal cracking apparatus along the central longitudinal axis thereof. For example, if there is only one heating element, then it is placed at or concentric with the central longitudinal axis, and if there is a plurality of the heating elements, then they are spaced or offset generally symmetrically or concentrically at locations near and around and parallel to the central longitudinal axis.

Thermal cracking to produce the carbon nanoparticles and aggregates described herein is generally achieved by passing the feedstock process gas over, or in contact with, or within the vicinity of, the heating element within a longitudinal elongated reaction zone generated by heat from the heating element and defined by and contained inside the body of the thermal cracking apparatus to heat the feedstock process gas to or at a specific molecular cracking temperature.

The reaction zone is considered to be the region surrounding the heating element and close enough to the heating element for the feedstock process gas to receive sufficient heat to thermally crack the molecules thereof. The reaction zone is thus generally axially aligned or concentric with the central longitudinal axis of the body. In some embodiments, the thermal cracking is performed under a specific pressure. In some embodiments, the feedstock process gas is circulated around or across the outside surface of a container of the reaction zone or a heating chamber in order to cool the container or chamber and preheat the feedstock process gas before flowing the feedstock process gas into the reaction zone.

In some embodiments, the carbon nanoparticles and aggregates described herein and/or hydrogen gas are produced without the use of catalysts. In other words, the process is catalyst free.

Some embodiments to produce the carbon nanoparticles and aggregates described herein using thermal cracking apparatuses and methods to provide a standalone system that can advantageously be rapidly scaled up or scaled down for different production levels as desired. For example, some embodiments are scalable to provide a standalone hydrogen and/or carbon nanoparticle producing station, a hydrocarbon source, or a fuel cell station. Some embodiments can be scaled up to provide higher capacity systems, e.g., for a refinery or the like.

In some embodiments, a thermal cracking apparatus for cracking a feedstock process gas to produce the carbon nanoparticles and aggregates described herein include a body, a feedstock process gas inlet, and an elongated heating element. The body has an inner volume with a longitudinal axis. The inner volume has a reaction zone concentric with the longitudinal axis. A feedstock process gas is flowed into the inner volume through the feedstock process gas inlet during thermal cracking operations. The elongated heating element is disposed within the inner volume along the longitudinal axis and is surrounded by the reaction zone. During the thermal cracking operations, the elongated heating element is heated by electrical power to a molecular cracking temperature to generate the reaction zone, the feedstock process gas is heated by heat from the elongated heating element, and the heat thermally cracks molecules of the feedstock process gas that are within the reaction zone into constituents of the molecules.

In some embodiments, a method for cracking a feedstock process gas to produce the carbon nanoparticles and aggregates described herein includes: (1) providing a thermal cracking apparatus having an inner volume that has a longitudinal axis and an elongated heating element disposed within the inner volume along the longitudinal axis; (2) heating the elongated heating element by electrical power to a molecular cracking temperature to generate a longitudinal elongated reaction zone within the inner volume; (3) flowing a feedstock process gas into the inner volume and through the longitudinal elongated reaction zone (e.g., wherein the feedstock process gas is heated by heat from the elongated heating element); and (4) thermally cracking molecules of the feedstock process gas within the longitudinal elongated reaction zone into constituents thereof (e.g., hydrogen gas and one or more solid products) as the feedstock process gas flows through the longitudinal elongated reaction zone.

In some embodiments, the feedstock process gas to produce the carbon nanoparticles and aggregates described herein includes a hydrocarbon gas. The results of cracking include hydrogen (e.g., H²) and various forms of the carbon nanoparticles and aggregates described herein. In some embodiments, the carbon nanoparticles and aggregates include two or more MWSFs and layers of graphene coating the MWSFs, and/or connected MWSFs and layers of graphene coating the connected MWSFs. In some embodiments, the feedstock process gas is preheated (e.g., to 100° C. to 500° C.) by flowing the feedstock process gas through a gas preheating region between a heating chamber and a shell of the thermal cracking apparatus before flowing the feedstock process gas into the inner volume. In some embodiments, a gas having nanoparticles therein is flowed into the inner volume and through the longitudinal elongated reaction zone to mix with the feedstock process gas, and a coating of a solid product (e.g., layers of graphene) is formed around the nanoparticles.

### Post-Processing High Purity Structured Carbons

In some embodiments, the carbon nanoparticles and aggregates containing multi-walled spherical fullerenes (MWSFs) or connected MWSFs described herein are produced and collected, and no post-processing is done. In other embodiments, the carbon nanoparticles and aggregates containing multi-walled spherical fullerenes (MWSFs) or connected MWSFs described herein are produced and collected, and some post-processing is done. Some examples of post-processing involved may include mechanical processing such as ball milling, grinding, attrition milling, micro fluidizing, and other techniques to reduce the particle size without damaging the MWSFs. Some further examples of post-processing include exfoliation processes such as sheer mixing, chemical etching, oxidizing (e.g., Hummer method), thermal annealing, doping by adding elements during annealing (e.g., sulfur, nitrogen), steaming, filtering, and lyophilizing, among others. Some examples of post-processing include sintering processes such as spark plasma sintering (SPS), direct current sintering, microwave sintering, and ultraviolet (UV) sintering, which can be conducted at high pressure and temperature in an inert gas. In some embodiments, multiple post-processing methods can be used together or in a series. In some embodiments, the post-processing produces functionalized carbon nanoparticles or aggregates containing multi-walled spherical fullerenes (MWSFs) or connected MWSFs.

In some embodiments, the materials are mixed together in different combinations. In some embodiments, different carbon nanoparticles and aggregates containing MWSFs or connected MWSFs described herein are mixed together before post-processing. For example, different carbon nanoparticles and aggregates containing MWSFs or connected MWSFs with different properties (e.g., different sizes, different compositions, different purities, from different processing runs, etc.) can be mixed together. In some embodiments, the carbon nanoparticles and aggregates containing MWSFs or connected MWSFs described herein can be mixed with graphene to change the ratio of the connected MWSFs to graphene in the mixture. In some embodiments, different carbon nanoparticles and aggregates containing MWSFs or connected MWSFs described herein can be mixed together after post-processing. For example, different carbon nanoparticles and aggregates containing MWSFs or connected MWSFs with different properties and/or different post-processing methods (e.g., different sizes, different compositions, different functionality, different surface properties, different surface areas) can be mixed together.

In some embodiments, the carbon nanoparticles and aggregates described herein are produced and collected, and subsequently processed by mechanical grinding, milling, and/or exfoliating. In some embodiments, the processing (e.g., by mechanical grinding, milling, exfoliating, etc.) reduces the average size of the particles. In some embodiments, the processing (e.g., by mechanical grinding, milling, exfoliating, etc.) increases the average surface area of the particles. In some embodiments, the processing by mechanical grinding, milling and/or exfoliation shears off some fraction of the carbon layers, producing sheets of graphite mixed with the carbon nanoparticles.

In some embodiments, the mechanical grinding or milling is performed using a ball mill, a planetary mill, a rod mill, a shear mixer, a high-shear granulator, an autogenous mill, or other types of machining used to break solid materials into smaller pieces by grinding, crushing or cutting. In some embodiments, the mechanical grinding, milling and/or exfoliating is performed wet or dry. In some embodiments, the mechanical grinding is performed by grinding for some period of time, then idling for some period of time, and repeating the grinding and idling for a number of cycles. In some embodiments, the grinding period is from 1 minute to 20 minutes, or from 1 minute to 10 minutes, or from 3 minutes to 8 minutes, or approximately 3 minutes, or approximately 8 minutes. In some embodiments, the idling period is from 1 minute to 10 minutes, or approximately 5 minutes, or approximately 6 minutes. In some embodiments, the number of grinding and idling cycles is from 1 minute to 100 minutes, or from 5 minutes to 100 minutes, or from 10 minutes to 100 minutes, or from 5 minutes to 10 minutes, or from 5 minutes to 20 minutes. In some embodiments, the total amount of time of grinding and idling is from 10 minutes to 1200 minutes, or from 10 minutes to 600 minutes, or from 10 minutes to 240 minutes, or from 10 minutes to 120 minutes, or from 100 minutes to 90 minutes, or from 10 minutes to 60 minutes, or approximately 90 minutes, or approximately 120 minutes. Of course, grinding, milling, or idling times within the scope of the presently disclosed inventive embodiments may have any of the foregoing values or be within any of the foregoing exemplary ranges, between any of the foregoing exemplary ranges, without limitation and without departing from the scope of the presently described inventive concepts.

In some embodiments, the grinding steps in the cycle are performed by rotating a mill in one direction for a first cycle (e.g., clockwise), and then rotating a mill in the opposite direction (e.g., counterclockwise) for the next cycle. In some embodiments, the mechanical grinding or milling is performed using a ball mill, and the grinding steps are performed using a rotation speed from 100 to 1000 rpm, or from 100 to 500 rpm, or approximately 400 rpm, or any value or range of values therebetween. In some embodiments, the mechanical grinding or milling is performed using a ball mill that uses a milling media with a diameter from 0.1 mm to 20 mm, or from 0.1 mm to 10 mm, or from 1 mm to 10 mm, or approximately 0.1 mm, or approximately 1 mm, or approximately 10 mm, or any value or range of values therebetween. In some embodiments, the mechanical grinding or milling is performed using a ball mill that uses a milling media composed of metal such as steel, an oxide such as zirconium oxide (zirconia), yttria stabilized zirconium oxide, silica, alumina, magnesium oxide, or other hard materials such as silicon carbide or tungsten carbide.

In some embodiments, the carbon nanoparticles and aggregates described herein are produced and collected, and subsequently processed using elevated temperatures such as thermal annealing or sintering. In some embodiments, the processing using elevated temperatures is done in an inert environment such as nitrogen or argon. In some embodiments, the processing using elevated temperatures is done at atmospheric pressure, or under vacuum, or at low pressure. In some embodiments, the processing using elevated temperatures is done at a temperature from 500° C. to 2500° C., or from 500° C. to 1500° C., or from 800° C. to 1500° C., or from 800° C. to 1200° C., or from 800° C. to 1000° C., or from 2000° C. to 2400° C., or approximately 800° C., or approximately 1000° C., or approximately 1500° C., or approximately 2000° C., or approximately 2400° C. Of course, processing using elevated temperatures may be performed at any of the foregoing temperatures, or at a temperature within any of the foregoing exemplary ranges, or between any of the foregoing exemplary ranges, without limitation and without departing from the scope of the presently described inventive concepts.

In some embodiments, the carbon nanoparticles and aggregates described herein are produced and collected, and subsequently, in post processing steps, additional elements or compounds are added to the carbon nanoparticles, thereby incorporating the unique properties of the carbon nanoparticles and aggregates into other mixtures of materials.

In some embodiments, either before or after post-processing, the carbon nanoparticles and aggregates described herein are added to solids, liquids or slurries of other elements or compounds to form additional mixtures of materials incorporating the unique properties of the carbon nanoparticles and aggregates. In some embodiments, the carbon nanoparticles and aggregates described herein are mixed with other solid particles, polymers or other materials.

In some embodiments, either before or after post-processing, the carbon nanoparticles and aggregates described herein are used in various applications beyond applications pertaining to the present description. Such applications including but not limited to transportation applications (e.g., automobile and truck tires, couplings, mounts, elastomeric o-rings, hoses, sealants, grommets, etc.) and industrial applications (e.g., rubber additives, functionalized additives for polymeric materials, additives for epoxies, etc.).

FIGS. 19A and 19B show transmission electron microscope (TEM) images of as-synthesized carbon nanoparticles. The carbon nanoparticles of FIG. 19A (at a first magnification) and FIG. 19B (at a second magnification) contain connected multi-walled spherical fullerenes 1902 (MWSFs) with graphene layers 1904 that coat the connected MWSFs. The ratio of MWSF to graphene allotropes in this example is approximately 80% due to the relatively short resonance times. The MWSFs in FIG. 19A are approximately 5 nm to 10 nm in diameter, and the diameter can be from 5 nm to 500 nm using the conditions described above. In some embodiments, the average diameter across the MWSFs is in a range from 5 nm to 500 nm, or from 5 nm to 250 nm, or from 5 nm to 100 nm, or from 5 nm to 50 nm, or from 10 nm to 500 nm, or from 10 nm to 250 nm, or from 10 nm to 100 nm, or from 10 nm to 50 nm, or from 40 nm to 500 nm, or from 40 nm to 250 nm, or from 40 nm to 100 nm, or from 50 nm to 500 nm, or from 50 nm to 250 nm, or from 50 nm to 100 nm. Of course, average MWSF diameter within the scope of the presently disclosed inventive embodiments may have any of the foregoing values or be within any of the foregoing exemplary ranges, or between any of the foregoing exemplary ranges, without limitation and without departing from the scope of the presently described inventive concepts. No catalyst was used in this process, and therefore, there is no central seed containing contaminants. The aggregate particles produced in this example had a particle size of approximately 10 μm to 100 μm, or approximately 10 μm to 500 μm.

FIG. 19C shows the Raman spectrum of the as-synthesized aggregates in this example taken with 532 nm incident light. The I_{D}/I_{G} for the aggregates produced in this example is from approximately 0.99 to 1.03, indicating that the aggregates were composed of carbon allotropes with a high degree of order.

FIG. 19D and FIG. 19E show example TEM images of the carbon nanoparticles after size reduction by grinding in a ball mill. The ball milling was performed in cycles with a 3 minute counter-clockwise grinding step, followed by a 6 minute idle step, followed by a 3 minute clockwise grinding step, followed by a 6 minute idle step. The grinding steps were performed using a rotation speed of 400 rpm. The milling media was zirconia and ranged in size from 0.1 mm to 10 mm. The total size reduction processing time was from 60 minutes to 120 minutes. After size reduction, the aggregate particles produced in this example had a particle size of approximately 1 μm to 5 μm. The carbon nanoparticles after size reduction are connected MWSFs with layers of graphene coating the connected MWSFs.

FIG. 19F shows a Raman spectrum from these aggregates after size reduction taken with a 532 nm incident light. The I_{D}/I_{G} for the aggregate particles in this example after size reduction is approximately 1.04. Additionally, the particles after size reduction had a Brunauer, Emmett and Teller (BET) specific surface area of approximately 40 m²/g to 50 m²/g.

The purity of the aggregates produced in this sample were measured using mass spectrometry and x-ray fluorescence (XRF) spectroscopy. The ratio of carbon to other elements, except for hydrogen, measured in 16 different batches was from 99.86% to 99.98%, with an average of 99.94% carbon.

In this example, carbon nanoparticles were generated using a thermal hot-wire processing system. The precursor material was methane, which was flowed from 1 slm to 5 slm. With these flow rates and the tool geometry, the resonance time of the gas in the reaction chamber was from approximately 20 second to 30 seconds, and the carbon particle production rate was from approximately 20 g/hr.

Further details pertaining to such a processing system can be found in the previously mentioned U.S. Pat. No. 9,862,602, titled “CRACKING OF A PROCESS GAS.”

FIG. 19G, FIG. 19H and FIG. 19I show TEM images of as-synthesized carbon nanoparticles of this example. The carbon nanoparticles contain connected multi-walled spherical fullerenes (MWSFs) with layers of graphene coating the connected MWSFs. The ratio of multi-walled fullerenes to graphene allotropes in this example is approximately 30% due to the relatively long resonance times allowing thicker, or more, layers of graphene to coat the MWSFs. No catalyst was used in this process, and therefore, there is no central seed containing contaminants. The as-synthesized aggregate particles produced in this example had particle sizes of approximately 10 μm to 500 μm. FIG. 19J shows a Raman spectrum from the aggregates of this example. The Raman signature of the as-synthesized particles in this example is indicative of the thicker graphene layers which coat the MWSFs in the as-synthesized material. Additionally, the as-synthesized particles had a Brunauer, Emmett and Teller (BET) specific surface area of approximately 90 m²/g to 100 m²/g.

FIG. 19K and FIG. 19L show TEM images of the carbon nanoparticles of this example. Specifically, the images depict the carbon nanoparticles after performance of size reduction by grinding in a ball mill. The size reduction process conditions were the same as those described as pertains to the foregoing FIG. 19G through FIG. 19J. After size reduction, the aggregate particles produced in this example had a particle size of approximately 1 μm to 5 μm. The TEM images show that the connected MWSFs that were buried in the graphene coating can be observed after size reduction. FIG. 19M shows a Raman spectrum from the aggregates of this example after size reduction taken with 532 nm incident light. The I_{D}/I_{G} for the aggregate particles in this example after size reduction is approximately 1, indicating that the connected MWSFs that were buried in the graphene coating as-synthesized had become detectable in Raman after size reduction, and were well ordered. The particles after size reduction had a Brunauer, Emmett and Teller (BET) specific surface area of approximately 90 m²/g to 100 m²/g.

FIG. 19N is a scanning electron microscope (SEM) image of carbon aggregates showing the graphite and graphene allotropes at a first magnification. FIG. 19O is a SEM image of carbon aggregates showing the graphite and graphene allotropes at a second magnification. The layered graphene is clearly shown within the distortion (wrinkles) of the carbon. The 3D structure of the carbon allotropes is also visible.

The particle size distribution of the carbon particles of FIG. 19N and FIG. 19O is shown in FIG. 19P. The mass basis cumulative particle size distribution 1906 corresponds to the left y-axis in the graph (Q³(x) [%]). The histogram of the mass particle size distribution 1908 corresponds to the right axis in the graph (dQ³(x) [%]). The median particle size is approximately 33 μm. The 10th percentile particle size is approximately 9 μm, and the 90th percentile particle size is approximately 103 μm. The mass density of the particles is approximately 10 g/L.

The particle size distribution of the carbon particles captured from a multiple-stage reactor is shown in FIG. 19Q. The mass basis cumulative particle size distribution 1914 corresponds to the left y-axis in the graph (Q³(x) [%]). The histogram of the mass particle size distribution 1916 corresponds to the right axis in the graph (dQ³(x) [%]). The median particle size captured is approximately 11 μm. The 10th percentile particle size is approximately 3.5 μm, and the 90th percentile particle size is approximately 21 μm. The graph in FIG. 19Q also shows the number basis cumulative particle size distribution 1918 corresponding to the left y-axis in the graph (Q⁰(x) [%]). The median particle size by number basis is from approximately 0.1 μm to approximately 0.2 μm. The mass density of the particles collected is approximately 22 g/L.

Returning to the discussion of FIG. 19P, the graph also shows a second set of example results. Specifically, in this example, the particles were size-reduced by mechanical grinding, and then the size-reduced particles were processed using a cyclone separator. The mass basis cumulative particle size distribution 1910 of the size-reduced carbon particles captured in this example corresponds to the left y-axis in the graph (Q³(x) [%]). The histogram of the mass basis particle size distribution 1912 corresponds to the right axis in the graph (dQ³(x) [%]). The median particle size of the size-reduced carbon particles captured in this example is approximately 6 μm. The 10th percentile particle size is from 1 μm to 2 μm, and the 90th percentile particle size is from 10 μm to 20 μm.

Further details pertaining to making and using cyclone separators can be found in U.S. patent application Ser. No. 15/725,928, filed Oct. 5, 2017, titled “MICROWAVE REACTOR SYSTEM WITH GAS-SOLIDS SEPARATION,” which is hereby incorporated by reference in its entirety.

### High Purity Carbon Allotropes Produced Using Microwave Reactor Systems

In some cases, carbon particles and aggregates containing graphite, graphene and amorphous carbon can be generated using a microwave plasma reactor system using a precursor material that contains methane, or contains isopropyl alcohol (IPA), or contains ethanol, or contains a condensed hydrocarbon (e.g., hexane). In some other examples, the carbon-containing precursors are optionally mixed with a supply gas (e.g., argon). The particles produced in this example contained graphite, graphene, amorphous carbon and no seed particles. The particles in this example had a ratio of carbon to other elements (other than hydrogen) of approximately 99.5% or greater.

In one particular example, a hydrocarbon was the input material for the microwave plasma reactor, and the separated outputs of the reactor comprised hydrogen gas and carbon particles containing graphite, graphene and amorphous carbon. The carbon particles were separated from the hydrogen gas in a multi-stage gas-solid separation system. The solids loading of the separated outputs from the reactor was from 0.001 g/L to 2.5 g/L.

FIG. 19R, FIG. 19S, and FIG. 19T are TEM images of as-synthesized carbon nanoparticles. The images show examples of graphite, graphene and amorphous carbon allotropes. The layers of graphene and other carbon materials can be clearly seen in the images.

The particle size distribution of the carbon particles captured is shown in FIG. 19U. The mass basis cumulative particle size distribution 1920 corresponds to the left y-axis in the graph (Q³(x) [%]). The histogram of the mass particle size distribution 1922 corresponds to the right axis in the graph (dQ³(x) [%]). The median particle size captured in the cyclone separator in this example was approximately 14 μm. The 10th percentile particle size was approximately 5 μm, and the 90th percentile particle size was approximately 28 μm. The graph in FIG. 19U also shows the number basis cumulative particle size distribution 1924 corresponding to the left y-axis in the graph (Q⁰(x) [%]). The median particle size by number basis in this example was from approximately 0.1 μm to approximately 0.2 μm.

FIG. 19V, FIG. 19W, and FIG. 19X, and 19Y are images that show three-dimensional carbon-containing structures that are grown onto other three-dimensional structures. FIG. 19V is a 100× magnification of three-dimensional carbon structures grown onto carbon fibers, whereas FIG. 19W is a 200× magnification of three-dimensional carbon structures grown onto carbon fibers. FIG. 19X is a 10000× magnification of three-dimensional carbon structures grown onto carbon fibers. The three-dimensional carbon growth over the fiber surface is shown. FIG. 19Y is a 10000× magnification of three-dimensional carbon structures grown onto carbon fibers. The image depicts growth onto the basal plane as well as onto edge planes.

More specifically, FIGS. 19V-19Y show example SEM images of 3D carbon materials grown onto fibers using plasma energy from a microwave plasma reactor as well as thermal energy from a thermal reactor. FIG. 19V shows an SEM image of intersecting fibers 1931 and 1932 with 3D carbon material 1930 grown on the surface of the fibers. FIG. 19W is a higher magnification image (the scale bar is 300 μm compared to 500 μm for FIG. 19V) showing 3D carbon growth 1930 on the fiber 1932. FIG. 19X is a further magnified view (scale bar is 40 μm) showing 3D carbon growth 1930 on fiber surface 1935, where the 3D nature of the carbon growth 1930 can be clearly seen. FIG. 19Y shows a close-up view (scale bar is 500 nm) of the carbon alone, showing interconnection between basal planes 1936 and edge planes 1934 of numerous sub-particles of the 3D carbon material grown on the fiber. FIGS. 19V-19Y demonstrate the ability to grow 3D carbon on a 3D fiber structure according to some embodiments, such as 3D carbon growth grown on a 3D carbon fiber.

In some embodiments, 3D carbon growth on fibers can be achieved by introducing a plurality of fibers into the microwave plasma reactor and using plasma in the microwave reactor to etch the fibers. The etching creates nucleation sites such that when carbon particles and sub-particles are created by hydrocarbon disassociation in the reactor, growth of 3D carbon structures is initiated at these nucleation sites. The direct growth of the 3D carbon structures on the fibers, which themselves are three-dimensional in nature, provides a highly integrated, 3D structure with pores into which resin can permeate. This 3D reinforcement matrix (including the 3D carbon structures integrated with high aspect ratio reinforcing fibers) for a resin composite results in enhanced material properties, such as tensile strength and shear, compared to composites with conventional fibers that have smooth surfaces and which smooth surfaces typically delaminate from the resin matrix.

### Functionalizing Carbon

In some embodiments, carbon materials, such as 3D carbon materials described herein, can be functionalized to promote adhesion and/or add elements such as oxygen, nitrogen, carbon, silicon, or hardening agents. In some embodiments, the carbon materials can be functionalized in situ—that is, within the same reactor in which the carbon materials are produced. In some embodiments, the carbon materials can be functionalized in post-processing. For example, the surfaces of fullerenes or graphene can be functionalized with oxygen- or nitrogen-containing species which form bonds with polymers of the resin matrix, thus improving adhesion and providing strong binding to enhance the strength of composites.

Embodiments include functionalizing surface treatments for carbon (e.g., CNTs, CNO, graphene, 3D carbon materials such as 3D graphene) utilizing plasma reactors (e.g., microwave plasma reactors) described herein. Various embodiments can include in situ surface treatment during creation of carbon materials that can be combined with a binder or polymer in a composite material. Various embodiments can include surface treatment after creation of the carbon materials while the carbon materials are still within the reactor.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A battery comprising:
a cylindrical shell defining an inner volume; and
a jelly roll disposed within the inner volume of the cylindrical shell, the jelly roll comprising:
an anode comprising lithium, wherein the anode is configured as a freestanding assembly having a first side and a second side,
a double-sided cathode, the double-sided cathode having a cathode current collector sandwiched between a sulfur-containing first layer of the cathode and a sulfur-containing second layer of the cathode,
a first separator between the first side of the anode and the first layer of the double-sided cathode, and
a second separator in direct contact with the second side of the anode and with the second layer of the double-sided cathode;
wherein the double-sided cathode comprises a plurality of particles, wherein each of the particles includes a first zone of first pores and a second zone of second pores.

2. The battery of claim 1, wherein the first pores have a uniform pore size.

3. The battery of claim 1, wherein the second zone concentrically positioned relative to the first zone and separated from the first zone by at least some of the first pores.

4. The battery of claim 1, wherein the second pores have a pore size that gradually decreases along a radial direction from the center of the particle to a boundary of the particle.

5. The battery of claim 1, wherein the double-sided cathode includes a plurality of aggregates, each including a multitude of the particles joined together.

6. The battery of claim 5, wherein each agglomerate of the plurality of aggregates includes a multitude of the aggregates joined together.

7. The battery of claim 1, wherein the double-sided cathode includes mesoporous carbon-based particles.

8. The battery of claim 1, wherein each mesoporous carbon-based particle of the mesoporous carbon-based particles includes a plurality of electrically conductive 3D aggregates.

9. The battery of claim 8, wherein the electrically conductive 3D aggregates are formed of graphene sheets randomly sintered together to form a 3D hierarchical open porous structure including mesoscale structuring in combination with micron-scale fractal structuring.

10. The battery of claim 9, wherein the plurality of electrically conductive 3D aggregates is configured to provide electrical conduction between contact points of the graphene sheets.

11. The battery of claim 9, wherein the first zone and the second zone include a porous arrangement defining a plurality of interconnected porous channels formed in the 3D hierarchical open porous structure.

12. The battery of claim 11, wherein the porous arrangement is configured to facilitate ion transport through at least some interconnected porous channels.

13. The battery of claim 1, wherein the second zone has a second electrical conductivity that is lower than a first electrical conductivity of the first zone.

14. The battery of claim 1, further comprising an electrolyte disposed in the battery, wherein the electrolyte is configured to inhibit transport of lithium-containing polysulfide intermediate species from the cathode to the anode.

15. The battery of claim 1, wherein at least one of the first separator or the second separator is configured for ion flow.

16. The battery of claim 1, wherein the cylindrical shell has a diameter in a range from approximately 18.4 millimeters to approximately 18.6 millimeters and a length in a range from approximately 65.1 millimeters to approximately 65.3 millimeters.

17. The battery of claim 1, wherein the cylindrical shell is congruent with an 18650 cell.

18. The battery of claim 1, wherein the double-sided cathode includes carbonaceous cathode active material including graphite, graphene nanoplatelets adjoined to one another, spherical fullerenes, carbon nano onions (CNOs), amorphous carbon, or any combination thereof.

19. The battery of claim 18, wherein the carbonaceous cathode active material comprises one or more films of interconnected agglomerates of tri-zone carbon particles.

20. The battery of claim 19, wherein the tri-zone particles include carbonaceous fragments nested within each other and separated from adjacent carbonaceous fragments by mesopores.
